(19) United States
(12) Patent Application Publication
(10) Pub. No.: US 2024/0422752 A1
(43) Pub. Date: Dec. 19, 2024

(54) METHODS, DEVICES, AND MEDIUM FOR COMMUNICATION

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 18/700,111

(22) PCT Filed: Oct. 13, 2021
(86) PCT No.: PCT/CN2021/123573

§ 371 Date: Apr. 10, 2024

(51) Int. Cl. H04W 72/0453; H04W 72/25

(52) U.S. Cl. CPC H04W 72/0453; H04W 72/25

(57) ABSTRACT

Example embodiments of the present disclosure relate to an effective mechanism for handing the scenario of discontinuous coverage. In this solution, the first terminal device receives receive a sidelink transmission on a first resource within a frequency bandwidth. Then the first terminal device determines at least one second resource within the frequency bandwidth for transmitting feedback information for the sidelink transmission, a frequency range occupied by the at least one second resource exceeding or being equal to a predefined percentage of the bandwidth, the at least one second resource comprising a common second resource and transmits the feedback information on the at least one second resource. In this way, the occupied channel bandwidth requirement for the feedback information of the sidelink transmission is ensured.

### FIELD

Example embodiments of the present disclosure generally relate to the field of communication techniques and in particular, to methods, devices, and medium of transmission of feedback information mechanism.

### BACKGROUND

Wireless communication networks are widely deployed and can support various types of service applications for terminal devices. Many communication schemes have been proposed to support the rapidly increasing data traffic. For example, a sidelink (SL) communication scheme has been proposed, where one or more SLs may be established between the terminal devices in the wireless communication network and the terminal devices may exchange signalling and data with each other directly via the established SL.

In the scenario that the SL communication is performed, the devices transmit SL control information associated with SL data on a physical sidelink control channel (PSCCH), and transmit the SL data on a physical sidelink shared channel (PSSCH) based on the SL control information. Further, in order to ensure the reliability of the SL transmission, it is specified that the physical sidelink feedback channel (PSFCH) is used to carry hybrid automatic repeat request (HARQ) feedback information from the receiving device to the transmitting device.

### SUMMARY

In general, example embodiments of the present disclosure provide a solution for the transmission of feedback information. Embodiments that do not fall under the scope of the claims, if any, are to be interpreted as examples useful for understanding various embodiments of the disclosure.

In a first aspect, there is provided a method of communication. The method comprises: receiving, at a first terminal device, a SL transmission on a first resource within a frequency bandwidth; determining at least one second resource within the frequency bandwidth for transmitting feedback information for the SL transmission, a frequency range occupied by the at least one second resource exceeding or being equal to a predefined percentage of the bandwidth, the at least one second resource comprising a common second resource; and transmitting the feedback information on the at least one second resource.

In a second aspect, there is provided a method of communication. The method comprises: receiving, at a first terminal device, an interlaced-based SL transmission on at least one first resource, the interlace-based SL transmission being transmitted with an interlace resource granularity larger than one; determining, at least in part based on the interlace resource granularity, a second resource for transmitting feedback information for the SL transmission; and transmitting the feedback information on the second resource.

In a third aspect, there is provided a method of communication. The method comprises: receiving, at a first terminal device, a SL transmission on a first resource; determining a second resource with a cyclic shift pair being specific to the first resource for transmitting feedback information for the SL transmission; and transmitting the feedback information on a second resource with the cyclic shift pair.

In a fourth aspect, there is provided a method of communication. The method comprises: receiving, at a first terminal device, an interlaced-based SL transmission on a first resource within a frequency bandwidth comprising a plurality of sets of interlaced resource blocks in frequency domain, the interlaced-based SL transmission is transmitted by a second terminal device via a group-cast; determining at least one second resource for transmitting feedback information for the SL transmission, the number of the at least one second resource is determined based on at least one of the following: a number of terminal devices involved in the group-cast, a number of the plurality of sets of interlaced resource blocks, and a number of cyclic shift pairs; and transmitting the feedback information on the at least one second resource.

In a fifth aspect, there is provided a method of communication. The method comprises: receiving, at a first terminal device, a SL transmission on at least one first resource; determining, from multiple of orthogonal frequency division multiplexing symbols within a single slot, at least one second resource for transmitting feedback information for the SL transmission; and transmitting the feedback information on the at least one second resource.

In a sixth aspect, there is provided a method of communication. The method comprises: receiving, at a first terminal device and from a second terminal device, a SL transmission on a first resource; determining, feedback resources for transmitting feedback information for the SL transmission, the feedback resources comprising a second resource and a third resource being different from the second resource; and transmitting the feedback information on at least part of the feedback resources.

In a seventh aspect, there is provided a method of communication. The method comprises: transmitting, at a second terminal device, a SL transmission on a first resource within a frequency bandwidth; determining, at least one second resource within the frequency bandwidth for receiving feedback information for the SL transmission, a frequency range occupied by the at least one second resource exceeding or being equal to a predefined percentage of the bandwidth, the at least one second resource comprising a common second resource; and receiving, the feedback information on the at least one second resource.

In an eighth aspect, there is provided a method of communication. The method comprises: transmitting, at a second terminal device, an interlaced-based SL transmission on at least one first resource, the interlace-based SL transmission being transmitted with an interlace resource granularity larger than one; determining, at least in part based on the interlace resource granularity, a second resource for receiving feedback information for the SL transmission; and receiving the feedback information on the second resource.

In a ninth aspect, there is provided a method of communication. The method comprises: transmitting, at a first terminal device, a SL transmission on a first resource; determining a second resource with a cyclic shift pair being specific to the first resource for receiving feedback information for the SL transmission; and receiving the feedback information on the second resource with the cyclic shift pair.

In a tenth aspect, there is provided a method of communication. The method comprises: transmitting, at a first terminal device and to a plurality of terminal devices comprising a first terminal device, an interlaced-based SL transmission on a first resource within a frequency bandwidth comprising a plurality of sets of interlaced resource blocks in frequency domain via a group-cast; determining at least one second resource for receiving feedback information for the SL transmission from the first terminal device, the number of the at least one second resource is determined based on at least one of the following: a number of terminal devices involved in the group-cast, a number of the plurality of sets of interlaced resource blocks, and a number of cyclic shift pairs; and receiving the feedback information on the at least one second resource.

In an eleventh aspect, there is provided a method of communication. The method comprises: transmitting, at a second terminal device, a SL transmission on at least one first resource; determining, from multiple of orthogonal frequency division multiplexing symbols within a single slot, at least one second resource for receiving feedback information for the SL transmission; and receiving the feedback information on the at least one second resource.

In a twelfth aspect, there is provided a method of communication. The method comprises: transmitting, at a second terminal device and to a first terminal device, a SL transmission on a first resource; determining, feedback resources for receiving feedback information for the SL transmission, the feedback resources comprising a second resource and a third resource being different from the second resource; and receiving the feedback information on at least part of the feedback resources.

In a thirteenth aspect, there is provided a terminal device. The terminal device includes a processing unit; and a memory coupled to the processing unit and storing instructions thereon, the instructions, when executed by the processing unit, causing the device to perform the method according to the first aspect.

In a fourteenth aspect, there is provided a terminal device. The terminal device includes a processing unit; and a memory coupled to the processing unit and storing instructions thereon, the instructions, when executed by the processing unit, causing the device to perform the method according to the second aspect.

In a fifteenth aspect, there is provided a terminal device. The terminal device includes a processing unit; and a memory coupled to the processing unit and storing instructions thereon, the instructions, when executed by the processing unit, causing the device to perform the method according to the third aspect.

In a sixteenth aspect, there is provided a terminal device. The terminal device includes a processing unit; and a memory coupled to the processing unit and storing instructions thereon, the instructions, when executed by the processing unit, causing the device to perform the method according to the fourth aspect.

In a seventeenth aspect, there is provided a terminal device. The terminal device includes a processing unit; and a memory coupled to the processing unit and storing instructions thereon, the instructions, when executed by the processing unit, causing the device to perform the method according to the fifth aspect.

In an eighteenth aspect, there is provided a terminal device. The terminal device includes a processing unit; and a memory coupled to the processing unit and storing instructions thereon, the instructions, when executed by the processing unit, causing the device to perform the method according to the sixth aspect.

In a nineteenth aspect, there is provided a terminal device. The terminal device includes a processing unit; and a memory coupled to the processing unit and storing instructions thereon, the instructions, when executed by the processing unit, causing the device to perform the method according to the seventh aspect.

In a twentieth aspect, there is provided a terminal device. The terminal device includes a processing unit; and a memory coupled to the processing unit and storing instructions thereon, the instructions, when executed by the processing unit, causing the device to perform the method according to the eighth aspect.

In a twenty-first aspect, there is provided a terminal device. The terminal device includes a processing unit; and a memory coupled to the processing unit and storing instructions thereon, the instructions, when executed by the processing unit, causing the device to perform the method according to the ninth aspect.

In a twenty-second aspect, there is provided a terminal device. The terminal device includes a processing unit; and a memory coupled to the processing unit and storing instructions thereon, the instructions, when executed by the processing unit, causing the device to perform the method according to the tenth aspect.

In a twenty-third aspect, there is provided a terminal device. The terminal device includes a processing unit; and a memory coupled to the processing unit and storing instructions thereon, the instructions, when executed by the processing unit, causing the device to perform the method according to the eleventh aspect.

In a twenty-fourth aspect, there is provided a terminal device. The terminal device includes a processing unit; and a memory coupled to the processing unit and storing instructions thereon, the instructions, when executed by the processing unit, causing the device to perform the method according to the twelfth aspect.

In a twenty-fifth aspect, there is provided a computer readable medium having instructions stored thereon, the instructions, when executed on at least one processor, causing the at least one processor to carry out the method according to any of the above first to twelfth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1A illustrates a conventionally slot format 100 of SL channel;

FIG. 1B illustrates a conventionally resource mapping correspondence;

FIG. 1C illustrates a proposed resource allocation for the interlace-based SL transmission;

FIG. 2 illustrates an example communication environment in which example embodiments of the present disclosure can be implemented;

FIG. 3 illustrates a signaling chart illustrating a process for communication according to some embodiments of the present disclosure;

FIG. 4 illustrates an example resource allocation for feedback information according to some embodiments of the present disclosure;

FIG. 5 illustrates an example resource mapping according to some embodiments of the present disclosure;

FIG. 6 illustrates an example resource mapping according to some embodiments of the present disclosure;

FIG. 7A illustrates an example resource mapping according to some embodiments of the present disclosure;

FIG. 7B illustrates a specific example correspondence between l and m₀ and according to some embodiments of the present disclosure;

FIG. 8A illustrates an example resource allocation according to some embodiments of the present disclosure;

FIG. 8B illustrates an example resource allocation according to some embodiments of the present disclosure;

FIG. 9A illustrates an example resource allocation according to some embodiments of the present disclosure;

FIG. 9B illustrates an example resource allocation according to some embodiments of the present disclosure;

FIG. 10 illustrates an example resource allocation according to some embodiments of the present disclosure;

FIG. 11 illustrates an example method performed by the first terminal device according to some embodiments of the present disclosure;

FIG. 12 illustrates an example method performed by the first terminal device according to some embodiments of the present disclosure;

FIG. 13 illustrates an example method performed by the first terminal device according to some embodiments of the present disclosure;

FIG. 14 illustrates an example method performed by the first terminal device according to some embodiments of the present disclosure;

FIG. 15 illustrates an example method performed by the first terminal device according to some embodiments of the present disclosure;

FIG. 16 illustrates an example method performed by the first terminal device according to some embodiments of the present disclosure;

FIG. 17 illustrates an example method performed by the second terminal device according to some embodiments of the present disclosure;

FIG. 18 illustrates an example method performed by the second terminal device according to some embodiments of the present disclosure;

FIG. 19 illustrates an example method performed by the second terminal device according to some embodiments of the present disclosure;

FIG. 20 illustrates an example method performed by the second terminal device according to some embodiments of the present disclosure;

FIG. 21 illustrates an example method performed by the second terminal device according to some embodiments of the present disclosure;

FIG. 22 illustrates an example method performed by the second terminal device according to some embodiments of the present disclosure; and

FIG. 23 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHZ), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As discusses above, the SL communication scheme has been proposed to support the rapidly increasing data traffic. A work item was conducted in the third Generation Partnership Project (3GPP) for the transmission of feedback information for the SL communication. Specifically, it is specified that the PSFCH is used to carry HARQ feedback information from a receiving terminal device to a transmitting terminal device.

Currently, a UE (i.e., a terminal device) can be indicated by a SL control information (SCI) format scheduling a PSSCH reception to transmit a PSFCH with HARQ-Acknowledgement (HARQ-ACK) information (i.e. the feedback information) in response to the PSSCH reception. The UE provides HARQ-ACK information that includes ACK or Negative-acknowledgement (NACK), or only NACK.

In conventional HARQ feedback information solution, the HARQ feedback information is transmitted on PSFCH in one PRB. The PSFCH carrying the HARQ feedback information is usually repeated over two orthogonal frequency division multiplexing (OFDM) symbols near the end of the SL resource in a slot.

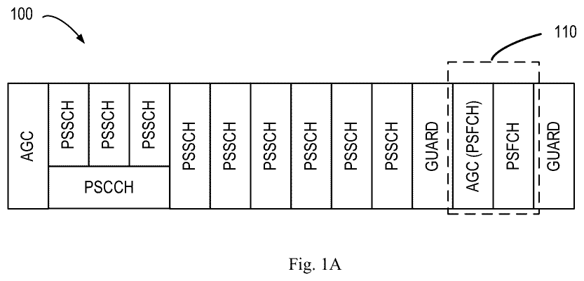

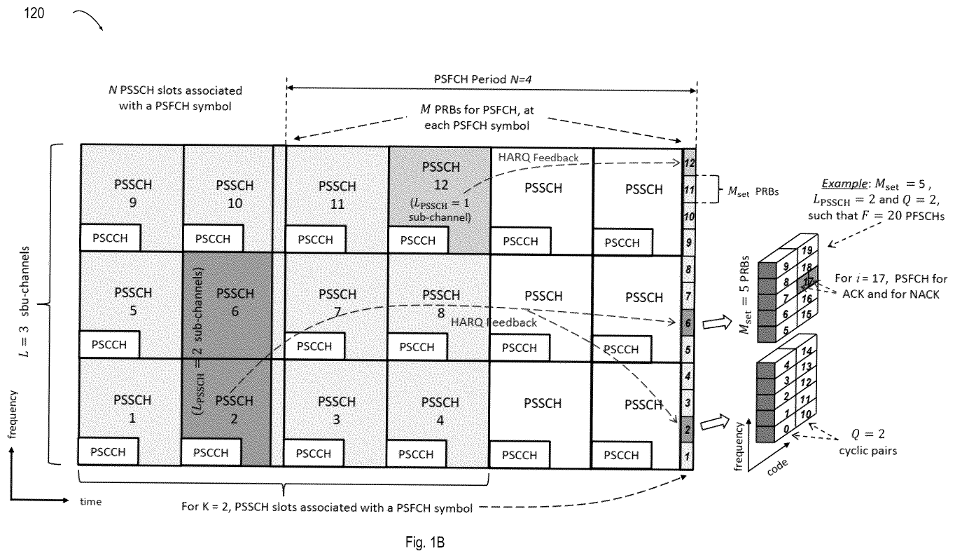

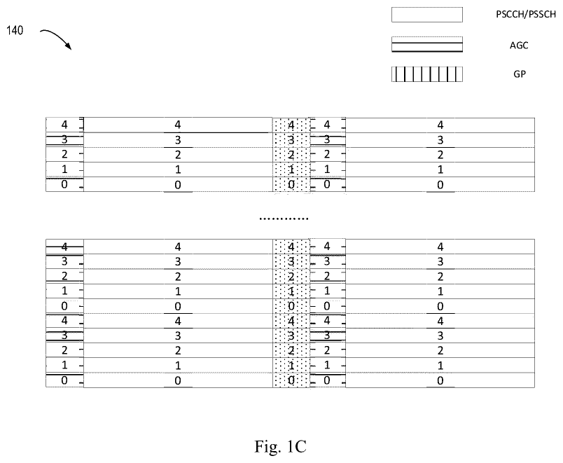

Reference is now made to FIG. 1A, which illustrates a conventionally slot format 100 of SL channel. As shown in FIG. 1A, the PSFCH carrying the HARQ feedback information is repeated over two OFDM symbols 110 (i.e., OFDM symbols #12 and #13).

In addition, the time resources for PSFCH may be (pre-) configured to occur once in every 1, 2, or 4 slots (referred to as PSFCH period). Further, the HARQ feedback resource (i.e., PSFCH) is derived from the resource location of PSCCH/PSSCH carrying the associated SL data.

In conventional HARQ feedback information solution, a UE can be provided, by sl-PSFCH-Period, a number of slots in a resource pool for a period of PSFCH transmission occasion resources. If the number is zero, PSFCH transmissions from the UE in the resource pool are disabled.

A UE expects that a slot t′ₖ^{SL} (0≤k<T′ₘₐₓ) has a PSFCH transmission occasion resource if k mod N_{PSSCH}^{PSFCH}=0, where t′ₖ^{SL} is defined in 3GPP standard of TS 38.214, and T′ₘₐₓ is a number of slots that belong to the resource pool within 10240 msec, and N_{PSSCH}^{PSFCH} is provided by sl-PSFCH-Period. In one example, a UE may be indicated by higher layers to not transmit a PSFCH in response to a PSSCH reception.

If a UE receives a PSSCH in a resource pool and the HARQ feedback enabled/disabled indicator field in an associated SCI format 2-A or a SCI format 2-B has value 1, the UE provides the HARQ-ACK information in a PSFCH transmission in the resource pool. The UE transmits the PSFCH in a first slot that includes PSFCH resources and is at least a number of slots, provided by sl-MinTimeGapPSFCH, of the resource pool after a last slot of the PSSCH reception.

A UE is provided by sl-PSFCH-RB-Set a set of N_{PRB,set}^{PSFCH} PRBs in a resource pool for PSFCH transmission in a PRB of the resource pool. For a number of N_{subch} sub-channels for the resource pool, provided by sl-NumSubchannel, and a number of PSSCH slots associated with a PSFCH slot that is less than or equal to N_{PSSCH}^{PSFCH}, the UE allocates the [(i+j·N_{PSSCH}^{PSFCH})·M_{subch, slot}^{PSFCH},(i+1+j·N_{PSSCH}^{PSFCH})·M_{subch, slot}^{PSFCH}−1] PRBs from N_{PRB,set}^{PSFCH} PRBs to slot i among the PSSCH slots associated with the PSFCH slot and sub-channel j, where M_{subch, slot}^{PSFCH}=M_{PRB, set}^{PSFCH}/(N_{subch}·N_{PSSCH}^{PSFCH}), 0≤i<N_{PSSCH}^{PSCCH}, 0≤j<N_{subch}, and the allocation starts in an ascending order of i and continues in an ascending order of j. The UE expects that M_{PRB, set}^{PSFCH} is a multiple of N_{subch}·N_{PSSCH}^{PSFCH}.

The second OFDM symbol l′ of PSFCH transmission in a slot is defined as l′=startSLsymbols+ lengthSLsymbols−2.

A UE determines a number of PSFCH resources available for multiplexing HARQ-ACK information in a PSFCH transmission as R_{PRB, CS}^{PSFCH}=N_{type}·M_{subch, slot}^{PSFCH}·N_{CS}^{PSFCH} where N_{CS}^{PSFCH} is a number of cyclic shift pairs for the resource pool provided by sl-NumMuxCS-Pair and, based on an indication by sl-PSFCH-CandidateResourceType,
if sl-PSFCH-CandidateResource Type is configured as startSubCH, N_{type}^{PSFCH}=1 and the M_{subch, slot}^{PSFCH} PRBs are associated with the starting sub-channel of the corresponding PSSCH; and
if sl-PSFCH-CandidateResourceType is configured as allocSubCH, N_{type}^{PSFCH}=N_{subch}^{PSSCH} and the N_{subch}^{PSSCH}·M_{subch, slot}^{PSFCH} PRBs are associated with the N_{subch}^{PSSCH} sub-channels of the corresponding PSSCH.

The PSFCH resources are first indexed according to an ascending order of the PRB index, from the N_{type}^{PSFCH}·M_{subch, slot}^{PSFCH} PRBs, and then according to an ascending order of the cyclic shift pair index from the N_{CS}^{PSFCH} cyclic shift pairs.

A UE determines an index of a PSFCH resource for a PSFCH transmission in response to a PSSCH reception as (P_{ID}+M_{ID})mod R_{PRB, CS}^{PSFCH} where P_{ID} is a physical layer source ID provided by SCI format 2-A or 2-B scheduling the PSSCH reception, and M_{ID} is the identity of the UE receiving the PSSCH as indicated by higher layers if the UE detects a SCI format 2-A with Cast type indicator field value of “01”; otherwise, M_{ID} is zero.

A UE determines a m₀ value, for computing a value of cyclic shift a, from a cyclic shift pair index corresponding to a PSFCH resource index and from N_{CS}^{PSFCH} using Table 1.

TABLE 1
Set of cyclic shift pairs

| | m₀ | | | | | |
|---|---|---|---|---|---|---|
| | Cyclic Shift | Cyclic Shift | Cyclic Shift | Cyclic Shift | Cyclic Shift | Cyclic Shift |
| | Pair Index | Pair Index | Pair Index | Pair Index | Pair Index | Pair Index |
| N_{CS}^{PSFCH} | 0 | 1 | 2 | 3 | 4 | 5 |
| 1 | 0 | — | — | — | — | — |
| 2 | 0 | 3 | — | — | — | — |
| 3 | 0 | 2 | 4 | — | — | — |
| 6 | 0 | 1 | 2 | 3 | 4 | 5 |

A UE determines a m_{cs} value, for computing a value of cyclic shift a, as in below Table 2 if the UE detects a SCI format 2-A with Cast type indicator field value of “01” or “10”, or as in Table 3 if the UE detects a SCI format 2-B or a SCI format 2-A with Cast type indicator field value of “11”. The UE applies one cyclic shift from a cyclic shift pair to a sequence used for the PSFCH transmission.

TABLE 2
Mapping of HARQ-ACK information bit values to a cyclic shift,
from a cyclic shift pair, of a sequence for a PSFCH transmission
when HARQ-ACK information includes ACK or NACK

| HARQ-ACK Value | 0 (NACK) | 1 (ACK) |
|---|---|---|
| Sequence cyclic shift | 0 | 6 |

TABLE 3
Mapping of HARQ-ACK information bit values to a cyclic shift,
from a cyclic shift pair, of a sequence for a PSFCH transmission
when HARQ-ACK information includes only NACK

| HARQ-ACK Value | 0 (NACK) | 1 (ACK) |
|---|---|---|
| Sequence cyclic shift | 0 | N/A |

Reference is now made to FIG. 1B, which illustrates a conventionally a resource mapping correspondence 120 disclosed in a document titled as “A Tutorial on 5G NR V2X Communications”, assigned with a digital object identifier (DOI) of 10.1109/COMST.2021.3057017. The entire disclosures of the document are herein incorporated by reference for better understanding the solution of FIG. 1B. In the example of FIG. 1B, the PSFCH period (represented by parameter N in the FIG. 1B) is 4 slots and the minimum slot gap between PSSCH/PSSCH and PSFCH (represented by parameter K in the FIG. 1B) is 2 slots.

In addition to the above, a scheme of interlace-based SL transmission is under discussion. The central concept of the interlace-based SL transmission is described with reference to FIG. 1C. FIG. 1C illustrates a proposed resource allocation 140 for the interlace-based SL transmission. In the specific example embodiment of FIG. 1C, the frequency resource comprises five sets of interlaced resource blocks (represented as interlace #0˜#4 in FIG. 1C), respectively. The SL transmission (i.e., PSSCH/PSSCH transmission) may be performed on the set(s) of interlaced resource blocks with an interlace resource granularity of ‘1’.

Although there are a plurality of discussions and proposals have been made for transmitting the feedback information, there are still multiple pending issues needed to be addressed.

One of the pending issues is how to ensure the transmission of feedback information satisfying occupied channel bandwidth (OCB) requirement. Specifically, the nominal channel bandwidth for a single operating channel is usually proposed to be 20 MHz and the OCB shall be between 80% and 100% of the declared nominal channel bandwidth. In this event, the listen-before-talk (LBT) procedure may be performed accurately to ensure fair coexistence of the different wireless communication systems. However, as discussed above, the feedback information for SL transmission is carried by two OFDM symbols within a PRB (as illustrated in FIG. 1A), which is obviously less than 16 MHz (i.e., the minimum occupied frequency required by OCB requirement in 20 MHz). Further, if introduce the concept of interlace-based transmission to the transmission of feedback information to satisfy the OCB requirement, the occasions for transmitting the feedback information would be decreased dramatically. Thus, it is desirable to propose an efficient solution to design resource allocation for PSFCH to satisfy OCB requirement.

Another pending issue is how to support transmitting the feedback information for group cast SL transmission with ACK and NACK feedback. Specifically, when the number of UEs in the group cast SL transmission increases, it is difficult to ensure that each UE may be configured a corresponding PSFCH resource.

A further pending issue is how to ensure the reliable transmission of feedback information. In conventional solutions, a failure of transmission of feedback information would cause an unnecessary re-transmission. Therefore, it is desirable to improve the reliability of PSFCH transmission.

It should be understood that the above illustrated issues are only for the purpose of illustration without suggesting any limitations. Both of the pending issues and the issues addressed by the present disclosure also are not limited to the above illustrated issues.

In the following text, the term “resource” or “transmission resource” may refer to any resource for performing a communication (for example, a communication between a terminal device and a network device, a communication between a terminal device and another terminal device, a network device and another network device), such as a resource in time domain, a resource in frequency domain, a resource in space domain, a resource in code domain, a resource in a combination of more than one domain or any other resource enabling a communication, and the like.

In the following text, a specific example embodiment will be discussed merely for better understanding. Specifically, the frequency bandwidth comprises 50 PRBs, or 5 sets of interlaced resource blocks (be represented as interlace #0˜interlace #4, respectively). Further, the PSFCH period is 2 slots, and the number of cyclic shift pairs being used is 3. It should be understood that the above values should not be considered as any limitations to the present disclosure. In other embodiments, the values of the number of PRBs, the number of interlaces (i.e., number of sets of interlaced resource blocks), the PSFCH period and the number of cyclic shift pairs may be replaced by any suitable values. The present disclosure is not limited in this regard.

Further, in the following description:
The terms “resource block (RB)” and “physical resource block (PRB)” may be used interchangeably.
The terms “nominal channel bandwidth”, “Bandwidth Part (BWP)”, and “bandwidth of resource pool” may be used interchangeably;
The terms “SL transmission” “PSSCH transmission” and “PSSCH/PSSCH transmission” may be used interchangeably;
The terms “granularity”, “unit”, and “minimum unit” may be used interchangeably; and
The terms “feedback information transmission” “HARQ ACK transmission” and “PSFCH transmission” may be used interchangeably.

Additionally, in the present disclosure, the terminal device may provide HARQ-ACK information in response to the PSSCH reception, and the HARQ-ACK information that includes only NACK (referred to as ‘Option 1’), or ACK and NACK (referred to as ‘Option 2’).

### Example Environment

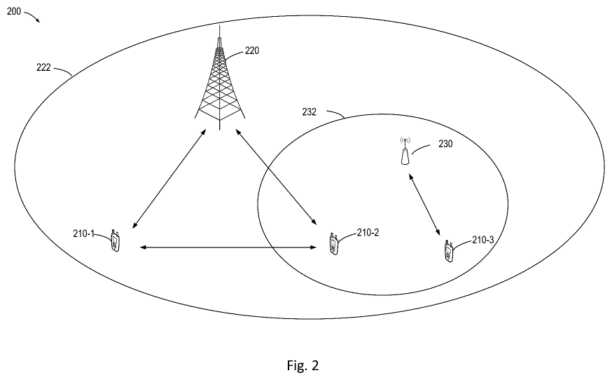

FIG. 2 shows an example communication environment 200 in which example embodiments of the present disclosure can be implemented.

The communication network 200 includes terminal devices 210-1 to 210-3, a first network device 220 and a second network device 230. In the following text, terminal devices 210-1 to 210-3 are referred to as a first terminal device 210-1, a second terminal device 210-2 and a third terminal device 210-3, respectively.

In the specific example embodiment of FIG. 2, a plurality of different wireless communication systems (such as, a cellular wireless system, a WiFi system and the like) coexist with each other. Specifically, in the specific example embodiment of FIG. 2, the first network device 220 is illustrated as a network device in a cellular wireless system, and the second network device 230 is illustrated as an access point in a WiFi system. The serving area of the first network device 220 is referred to as cell 222, and the first network device 220 may communicate with the first terminal device 210-1, the second terminal device 210-2 and the third terminal device 210-3 via physical communication channels or links. Similarly, the serving area of the second network device 230 is referred to as cell 232, and the second network device 230 may communicate with the second terminal device 230-2 and the third terminal device 210-3 via physical communication channels or links.

Further, communications on unlicensed resource (such as, unlicensed spectrum) are supported in the communication network 200. In other words, the unlicensed resource may be shared by the different wireless communication systems (i.e., the cellular wireless system and the WiFi system).

In addition, the SL communication is supported in communication network 200. As illustrated in FIG. 2, the first terminal device 210-1 and the second terminal device 210-2 may receive control information (such as, resource configuration message) from the first network device 220 and may communicate with each other directly via an established SL.

The communications in the communication environment 200 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices (i.e., the terminal devices 210, the first network device 220 and the second network device 230) and their connection relationships and types shown in FIG. 2 are only for the purpose of illustration without suggesting any limitation. The communication network 200 may include any suitable numbers of devices adapted for implementing embodiments of the present disclosure.

### Example Processes of Transmission of Feedback Information

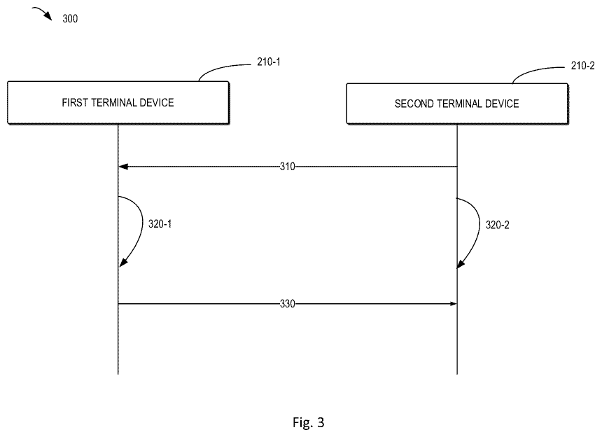

Principle and implementations of the present disclosure will be described in detail below with reference to FIG. 3-10.

Reference is made to FIG. 3 first, which shows a signaling chart illustrating a process 300 of communication according to some example embodiments of the present disclosure. For the purpose of discussion, the process 300 will be described with reference to FIG. 2. The process 300 may involve the first terminal device 210-1 and the second terminal device 210-2.

In the specific example embodiment of FIG. 3, the first terminal device 210-1 receives 310 SL transmissions (such as, PSSCH/PSCCH) from the second terminal device 210-2 on a first resource within a frequency bandwidth. Next, the first terminal device 210-1 determines 320-1 at least one second resource within the frequency bandwidth for transmitting feedback information (i.e., PSFCH) for the SL transmission. The second terminal device 210-2 determines 320-2 at least one second resource correspondingly, such that the operations at the first terminal device 210-1 and the second terminal device 210-2 may be consistent with each other. Then, the first terminal device 210-1 transmits 330 the feedback information on the at least one second resource to the second terminal device 210-2.

In some embodiments, all the PRB resources within the nominal channel bandwidth may be used for the feedback information (i.e., PSFCH) transmission by a default configuration. Specifically, the configured availably resources for transmitting the feedback information comprises: all the PRB resources in frequency domain and one or two (repeated) OFDM symbols before the last guard symbol in time domain.

In one specific example embodiment, all the PRBs in frequency domain in a resource pool are provided for PSFCH transmission. Additionally, in some embodiments, each interlace may contain a certain number (such as, 10) of uniform distributed single PRBs. Alternatively, in some embodiments, each interlace may contain a set of contiguous PRBs (such as, 10 PRBs).

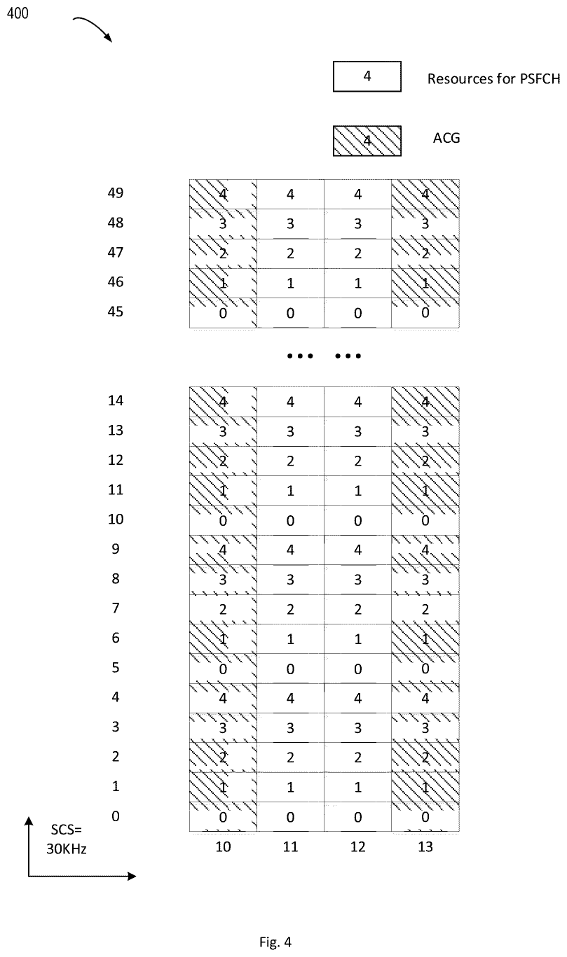

Reference is now made FIG. 4, which illustrates a specific example resource allocation 400 for feedback information according to some embodiments of the present disclosure. In the specific example embodiment of FIG. 4, in case that the sub-carrier space (SCS) is 30 kHz, there may be 50 PRBs (be represented as PRB #0˜PRB #49 in FIG. 4) or 5 interlaces (be represented as interlace #0˜interlace #4 in FIG. 4) in frequency, and all the 50 PRBs/5 interlaces may be configured for the PSFCH transmission.

According to the present disclosure, the procedure of transmitting the feedback information is improved. In the following text, example embodiments for the improved procedure will be discussed. It should be understood that although feature(s)/operation(s) are discussed in specific example embodiments separately, unless clearly indicated to the contrary, these feature(s)/operation(s) described in different example embodiments may be used in any suitable combination.

In some embodiments, the resource used for PSFCH (i.e., the second resource(s)) may be sub-PRB based interlace, for example, subcarrier-based interlace. As one specific embodiments, the second resource(s) is a set of certain subcarriers, such as, the first subcarrier #0 of each PRB within a certain PRB-based interlace resource (such as, interlace #0).

### Example Processes for Common PSFCH Resources

In accordance with some example embodiments of the present disclosure, there is provided a solution for communication. In this solution, frequency range occupied by the at least one second resource exceeding or being equal to a predefined percentage of the bandwidth. In some example embodiments, the predefined percentage is between 80%˜100%. In some embodiments, the at least one second resource comprises a common second resource. In other words, a dedicated resource (such as, one dedicated interlace in PSFCH symbols) is reserved for the common PSFCH transmission.

In particular, in some embodiments, the common second resource shared by one SL transmission and a further SL transmission. Specifically, the common second resource may corresponding to different PDSSCH/PDCCH transmission occasions via unicast or group cast, or PDSSCH/PDCCH transmission to different user with same PDSSCH/PDCCH transmission occasions via group cast. In one example embodiment, in case that the first terminal device 210-1 receives a first SL transmission on interlace #0 and a second SL transmission on interlace #2, both the first and second SL transmission may be fed back on the common second resource. For another example embodiment, if the second terminal device 210-2 transmits a first SL transmission to the first terminal device 210-1 and a second SL transmission to a further terminal device, both the first and second SL transmission also may be fed back on the common second resource.

It should be understood that, the key purpose of the common second resource is once the terminal device transmit feedback information on the common second resource, the OCB requirement would be satisfied. Further, the common second resource may be shared by different SL transmissions/PDSSCH/PDCCH transmission occasions/different terminal devices. The present disclosure is not limited in this regard.

Alternatively, in some embodiments, the remaining resources/PRBs rather than the PSFCH common second resource is regarded as the resource M_{PRB,set}^{PSFCH} used in TS 38213 (provided by sl-PSFCH-RB-Set a set of M_{PRB,set}^{PSFCH} PRBs in a resource pool for PSFCH transmission in one PRB).

In some embodiments, the feedback information transmitted in the common second resource is pre-defined common feedback information. In other words, one dedicated signal is reserved as the common feedback information that can only be transmitted in the common PSFCH transmission occasion.

In some embodiments, a predefined PUCCH format sequence may be used as the common feedback information by an indicated/(pre-) configured cyclic shift pair m₀ and cyclic shift value m_{cs}. In one specific embodiment, the pre-defined common feedback information is a pre-defined sequence for a physical uplink control channel message or a proper sequence. In another specific embodiment, the pre-defined common feedback information is a RS.

It is to be understood that the above examples of pre-defined common feedback information are only for the purpose of illustration without suggesting any limitations. In the other example embodiments, the pre-defined common feedback information may be any pre-configured sequence.

By pre-defining common feedback information, the transmissions of common feedback information transmitted by more than one terminal device will not interfere with each other.

In some embodiments, if a UE receives a PSSCH in a resource pool and the HARQ feedback enabled/disabled indicator field in an associated SCI format is enabled (i.e., configured to be “1”), the UE transmits the common HARQ-ACK information om the common PSFCH transmission in the resource pool.

In some embodiments, the common second resource is configured by the second terminal device 210-2 (i.e., the transmitting device) or the first network device 220 via such as SCI messages.

Alternatively, the common second resource may be determined according to a default configuration. For example, the common second resource is defined/configured/stipulated by the wireless standards (such as, 3GPP), the network operator or the service provider.

In some embodiments, the frequency bandwidth comprises a plurality of sets of interlaced resource blocks in frequency domain, and the common second resource corresponds to one of the plurality of sets of interlaced resource blocks.

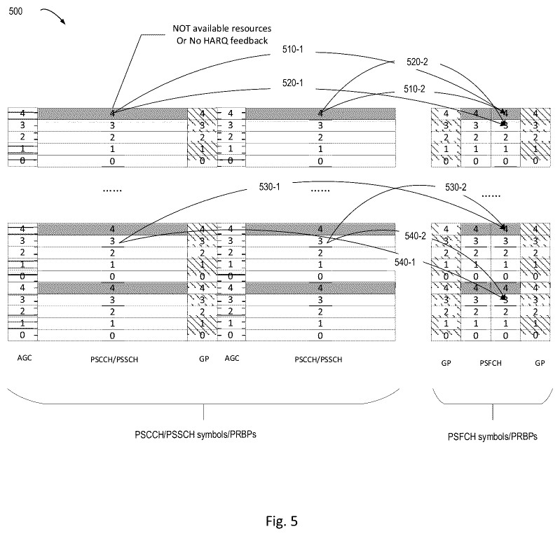

Reference is now made FIG. 5, which illustrates a specific example resource mapping 500 according to some embodiments of the present disclosure. In the specific example embodiment of FIG. 5, the frequency bandwidth comprises 5 sets of interlaced resource blocks (be represented as interlace #0˜interlace #4 in FIG. 5) in frequency domain, and the common second resource corresponds to a specific interlace (i.e., the interlace #4 as illustrated in FIG. 5).

In some embodiments, the SL transmission is an interlace-based SL transmission, and the at least one first resource and the common second resource corresponds to different interlace indexes. The first terminal device 210-1 and the second terminal device 210-2 may determine both a common second resource and a dedicated second resource being specific to the SL transmission (a part of resource in interlace #0/1/2/3).

In the specific example embodiment of FIG. 5, interlace #4 is reserved as common second resource. As illustrated by mapping 530-1, 530-2, 540-1 and 540-2, the feedback information for the SL transmission on interlace #0/1/2/3 is carried on both the interlace #4 and a dedicated second resource in interlace #0/1/2/3 (i.e., interlace 3 as illustrated in FIG. 5).

In some embodiments, the dedicated second resource may be determined according to one or more factors. One example factor is the plurality of sets of interlaced resource blocks (i.e., available interlace number, represented as “I_PSSCH”). In the specific example embodiment of FIG. 5, the number of the plurality of sets of interlaced resource blocks is 5. Another example factor is an interlace index corresponding to the at least one first resource. A further example factor is a period for transmitting the feedback information. In the specific example embodiment of FIG. 5, the period of transmitting the feedback information is two slots (i.e., PSFCH period, represented as “P”).

In some embodiments, the remaining PRBs rather than the common second resource are divided into a plurality of sets of PRB by the number of potential PSSCH/PSCCH transmission occasions in the associated slots, and each divided set is associated with each potential PSSCH/PSCCH transmission. In some embodiments, the number of potential PSSCH/PSCCH transmissions occasion in the associated slots is derived from a period for transmitting the feedback information (i.e., PSFCH period) and the number of the plurality of sets of interlaced resource blocks (i.e., interlace number).

In the specific example embodiment of FIG. 5, the M_{PRB,set}^{PSFCH}=the total available PRBs−the common second resource=50−10=40, and the number of potential PSSCH/PSCCH transmission occasions=available interlace number (I_PSSCH)*PSFCH period (P)=5*2=10.

In some example, the first terminal device 210-1 and the second terminal device 210-2 may determine the dedicated second resource according to the 3GPP standard TS 38.213.

Additionally, in some embodiments, if a number of sets of interlaced resource blocks occupied by the SL transmission is larger than one, the dedicated second resource is determined further based on the number of sets of interlaced resource blocks occupied by the SL transmission. In the specific example embodiment of FIG. 5, in case that the SL transmission (i.e., PSSCH/PSCCH) is configured on more than one interlaces (such as, interlaces #0˜#2), the feedback information for the SL transmission on interlaces #0˜#2 may be carried either only on interlace #0 or on both of interlaces #0˜#2, which means that the number of potential PSFCH transmission occasions is associated with the number of sets of interlaced resource blocks occupied by the SL transmission.

It should be understood that the examples for determining the dedicated second resource are only for the purpose of illustration without suggesting any limitations. In some other example embodiments, the first terminal device 210-1 and the second terminal device 210-2 may determine the dedicated second resource according to any suitable rules. Moreover, the dedicated second resource may be one or two OFDM symbols in one PRB, which means that the dedicated second resource is not required to satisfy the OCB requirement.

Still refer to FIG. 5, assume that the feedback information for the SL transmission on interlace #4 would be carried on PSFCH resources with interlace #4 according to the conventional solutions. In this event, as the interlace #4 has been configured as a common second resource, the feedback information for the SL transmission on interlace #4 should be further discussed accordingly.

In some embodiments, if a dedicated interlace (such as, interlace #4 as shown in FIG. 5) is configured as the common second resource, the corresponding dedicated interlace #4 in PSSCH/PSCCH symbols should not be regarded as available resources for PSCCH/PSSCH transmission. In one specific example embodiment, the SL transmission is an interlace-based SL transmission and the common second resource corresponds to a first interlace index. The first device 210-1 may disable receiving a SL transmission transmitted on a resource corresponding to the first interlace index. Correspondingly, the second terminal device 210-2 may disable transmitting a SL transmission transmitted on a resource corresponding to the first interlace index, or alternatively avoid selecting the resource corresponding to the first interlace index to be used for a SL transmission during resource (re) selection.

In the specific example embodiment of FIG. 5, interlace #4 is reserved as common second resource. In one implementation, interlace #4 should not considered as available for the SL transmission (i.e., PSCCH/PSSCH transmission). In other worlds, no SL transmission is performed on interlace #4.

Alternatively, in some embodiments, if a dedicated interlace (such as, interlace #4 as shown in FIG. 5) is configured as the common second resource, the dedicated interlace #4 in the PSSCH/PSCCH symbols could only be selected for PSCCH/PSSCH transmission whose HARQ-ACK feedback is disabled during resource (re) selection. In one specific example embodiment, the SL transmission is an interlace-based SL transmission and the common second resource corresponds to a first interlace index. The first device 210-1 may disable transmitting feedback information for a SL transmission transmitted on a resource corresponding to the first interlace index. Correspondingly, the second terminal device 210-2 may disable receiving feedback information for a SL transmission transmitted on a resource corresponding to the first interlace index.

In the specific example embodiment of FIG. 5, interlace #4 is reserved as common second resource. In one implementation, the second terminal device 210-1 may perform SL transmission on interlace #4, while no feedback information is needed for the SL transmission on interlace #4.

Alternatively, in some embodiments, if a dedicated interlace (such as, interlace #4 as shown in FIG. 5) is configured as the common second resource, no restriction is imposed on interlace #4 in the PSSCH/PSCCH symbols. Specifically, interlace #4 in the PSSCH symbols may be selected for either a SL transmission enabling HARQ feedback or a SL transmission disabling HARQ feedback. In one specific example embodiment, the SL transmission is an interlace-based SL transmission and the common second resource corresponds to a first interlace index. The first terminal device 210-1 and the second terminal device 210-2 may determine both a common second resource and a dedicated second resource being specific to the SL transmission.

In the specific example embodiment of FIG. 5, interlace #4 is reserved as common second resource. In one implementation, according to the mapping 510-1, 510-2, 520-1 and 520-2, the feedback information for the SL transmission on interlace #4 may be carried on both interlace #4 and a dedicated second interlace (i.e., interlace #3 as shown in FIG. 5). The processes for determining the dedicated second interlace has been described previously. For brevity, same or similar contents are omitted here.

In this way, by introducing the common second resource, even the first terminal device 210-1 merely transmits the actual feedback information (i.e., PSFCH) within one PRB, the transmission of feedback information still may satisfy the OCB requirement.

### Example Processes for Increasing the Interlace Resource Granularity

In conventional solutions, an interlace is considered as the minimum unit for performing the SL transmission. In this event, as discusses above, the PSSCH/PSCCH transmission occasions may be calculated as: PSSCH/PSCCH transmission occasions=available interlace number (I_PSSCH)*PSFCH period (P). Further, the PSFCH transmission occasions may be calculated as: available interlace number (I_PSFCH)*cyclic shift pair number (N). Then, the number of PSFCH transmission occasions associated with each PSSCH/PSCCH transmission occasion is may be calculated as: cyclic shift pair number (N)/PSFCH period (P), which is difficulty to support a scenario of group cast SL transmission.

In accordance with some example embodiments of the present disclosure, the interlace resource granularity (represented by parameter ‘L’) may be configured with a value larger than one. In this way, the number PSSCH/PSCCH transmission occasions is reduced, and the number of PSFCH transmissions occasions associated with each PSSCH/PSCCH transmissions occasion is increased. Specifically, the number of the interlaced occupied by the SL transmission is a plurality of the interlace resource granularity.

In accordance with some example embodiments of the present disclosure, the PSSCH/PSCCH transmission occasions may be calculated as: PSSCH/PSCCH transmission occasions=available interlace number (I_PSSCH)*PSFCH period (P)/interlace resource granularity (L). Therefore, the number the PSSCH/PSCCH transmission occasions is reduced by L times. As a result, the number of PSFCH transmissions occasions associated with each PSSCH/PSCCH transmission occasion is increased by L times.

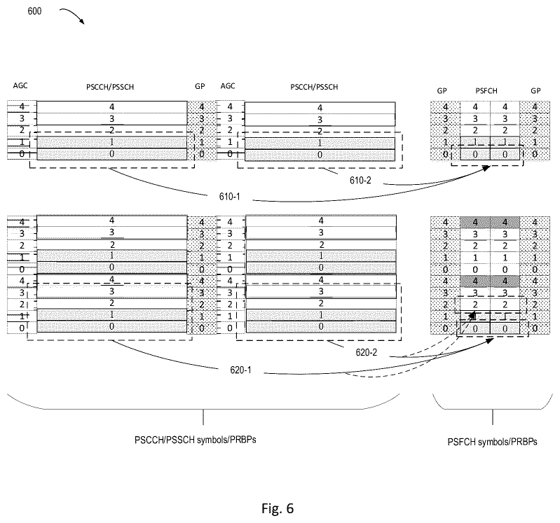

Reference is now made FIG. 6, which illustrates a specific example resource mapping 600 according to some embodiments of the present disclosure. In the specific example embodiment of FIG. 6, the interlace resource granularity is two, which means that the number of interlaces occupied by the SL transmission may be, 2, 4 and other even number. Further, in the specific example embodiment of FIG. 6, as illustrated by mapping 610-1 and 610-2, the feedback information for the SL transmission may be transmitted on interlace #0.

In some embodiments, the second resource for transmitting the feedback information is comprised in a feedback resource pool, and the feedback resource pool comprised resources in frequency domain and resources in code domain (such as, a plurality of cyclic shift pairs). Additionally, the resources in the feedback resource pool are indexed in an order of from a frequency domain to a code domain.

In one specific example embodiment, the first terminal device 210-1 and the second terminal device 210-2 determine an index of a PSFCH resource for a PSSCH to be (P_{ID}+M_{ID}) mod R, where P_{ID} is a physical layer source ID scheduling the PSSCH reception, and M_{ID} is the identity of the UE receiving the PSSCH as indicated by higher layers if the UE detects a SCI format 2-A with Cast type indicator field value of “01”; otherwise, M_{ID} is zero.

In one specific example, each resource of PSFCH resources contains one interlace in frequency domain and one cyclic shift in code domain. The first terminal device 210-1 sends the corresponding feedback information (HARQ-ACK sequence) in each PRB of the interlace, i.e., duplicated in every PRB of the interlace.

As described above, the number of the interlaced occupied by the SL transmission is a plurality of the interlace resource granularity. In some embodiments, when a SL transmission occupies M granularities, the corresponding interlaces for PSFCH transmission could be one interlace which associated with the lowest one of the plurality of granularities. In the specific embodiment of FIG. 6, the SL transmission occupies two granularities (i.e., interlaces #0˜#3). As illustrated by mapping 620-1 and 620-2, the feedback information for the SL transmission may be transmitted on interlace #0.

Alternatively, when a PSSCH occupies M granularities, the corresponding interlaces for PSFCH transmission could be M interlaces associated with all of the plurality of granularities. In the specific embodiment of FIG. 6, the SL transmission occupies two granularities (i.e., interlaces #0˜#3). As illustrated by mapping 620-1 and 620-2, the feedback information for the SL transmission may be transmitted on interlace #0 and interlace #2.

Alternatively, when a PSSCH occupies M granularities, the corresponding interlaces for PSFCH transmission could be all of the interlaces associated with all of the plurality of granularities. In the specific embodiment of FIG. 6, in case that the SL transmission occupies two granularities (i.e., interlaces #0˜#3) and the feedback information for the SL transmission also may be transmitted on interlaces #0˜#3.

In some embodiments, in addition to increasing the interlace resource granularity, the PSFCH period also may be decreased (for example, decreased to be ‘1’). In this event, the number of PSSCH/PSCCH transmission occasions may be decreased to be I_PSSCH*1. As a result, the number the PSFCH transmission occasion associated with each PSSCH/PSCCH transmission occasion is increased.

In this way, the number of terminal devices in a group caser SL transmission maybe increased.

### Example Processes for Pre-Configured Cyclic Shift Pair

In conventional solutions, the PSFCH resource is determined by P_{ID} in some cases (such as, unicast SL transmission or group cast Option 1 in which the terminal device only needs one PSFCH resource).

For interlace-based PSSCH/PSFCH transmission, the PSFCH resources (i.e., same PRB with different cyclic shift) are determined by: P_{ID} mode the number of PSFCH transmission occasions. However, the number of PSFCH transmission occasions is relatively smaller, which causes that PSSCH/PSCCH transmissions in different slots with different P_{ID}S may still determine same PSFCH resources (i.e., same m₀), which is unexpected for the first terminal device 210-1 and the terminal device 210-2.

In accordance with some example embodiments of the present disclosure, it is expected that I_PSFCH*N_{cs}>=I_PSSCH*P/L, and further expected that PSSCH/PSCCH transmissions in different slots may be configured with different cyclic shift pairs.

In some embodiment, a feedback configuration about disabling SL transmission transmitted via a group-cast is applied in the network. Alternatively, in some embodiment, a feedback configuration about enabling feedback information only comprising NACK is applied in the network. In this way, the scenario of group cast Option 2 is disabled.

In some embodiments, the first terminal device 210-1 receives a SL transmission on a first resource, and then determines a second resource with a cyclic shift pair being specific to the first resource for transmitting feedback information for the SL transmission.

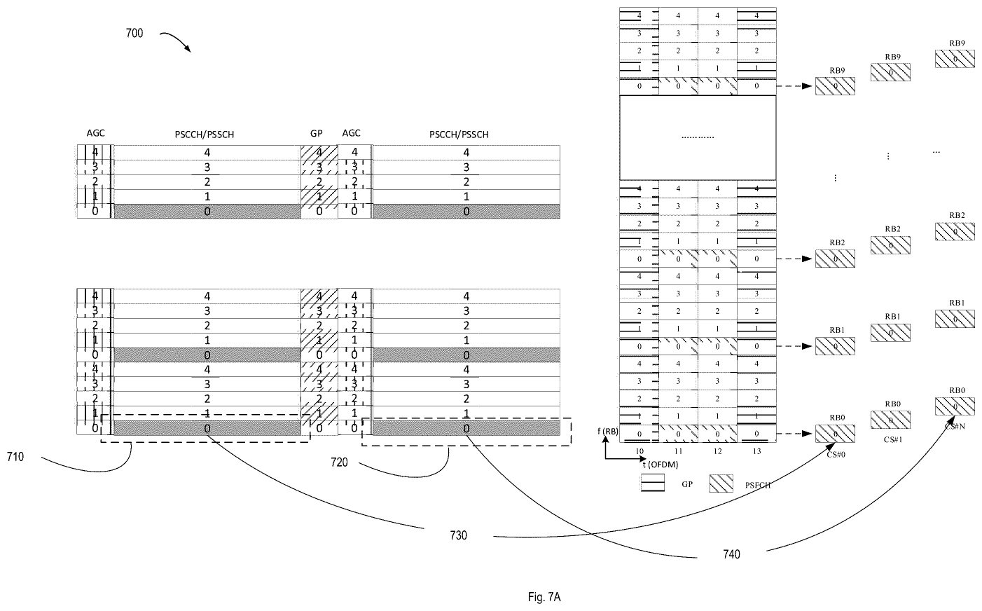

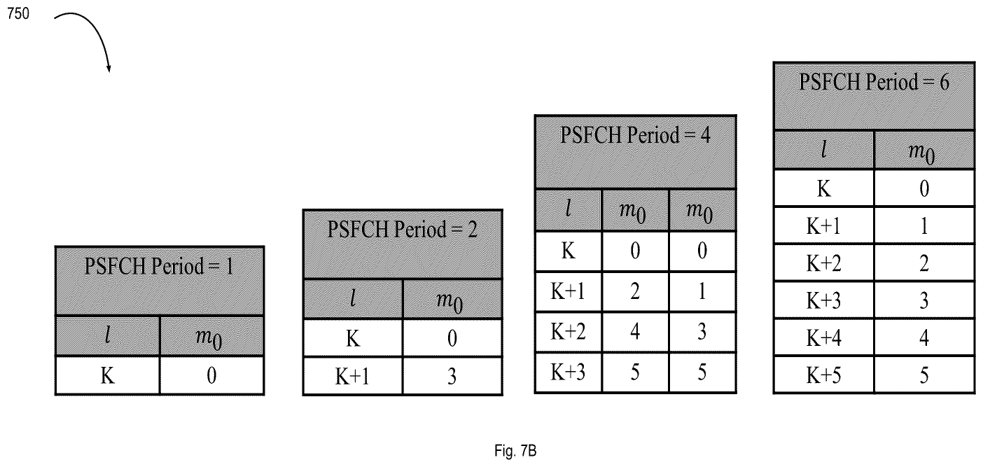

Reference is now made FIG. 7A, which illustrates a specific example resource mapping 700 according to some embodiments of the present disclosure. In the specific example embodiment of FIG. 7, according to the mapping 730, the feedback information for the SL transmission 710 is carried on interlace #0 with cyclic shift #1. Similarly, according to the mapping 740, the feedback information for the SL transmission 720 is carried on interlace #0 with cyclic shift #N.

In some embodiments, the cyclic shift pair is determined based on a pre-configured correspondence between: a distance between the first resource and the second resource in time domain (be represented as ‘l’), and an index of the cyclic shift pair (i.e., m₀).

Reference is now made FIG. 7B, which illustrates a specific example correspondence between the distance and the index of the cyclic shift pair for different PSFCH periods.

In one specific embodiment, the first terminal device 210-1 and the second terminal device 210-2 determine the second resource (such as, a dedicated interlace or a PRB) according to such as any of the embodiments discussed in the present disclosure.

Then, the first terminal device 210-1 and the second terminal device 210-2 determine the index of cyclic shift pair based on correspondence between the distance between the first resource and the second resource in time domain (such as, K, K+1, K+2, and so on, where K is the minimum slot gap between PSFCH slot and the PSSCH/PSCCH slot) and the index of the cyclic shift pair (as illustrated in FIG. 7B).

In this way, different PSSCH/PSCCH transmission occasions may correspond to different cyclic shift pairs. In case that the terminal device only needs one PSFCH resource (such as, a scenario of unicast or group cast option 1), it may be avoided that the PSSCH/PSCCH transmissions in different slots correspond to same PSFCH resource.

### Example Processes for Group Case SL Transmission

In conventional solutions, the OCB is calculated per UE. As discussed above, the OCB is usually used for the LBT procedure, and the LBT procedure may be performed among a plurality of different wireless communication systems. For example, in the specific example of FIG. 2, a plurality of different wireless communication systems (such as, a cellular wireless system, a WiFi system and the like) coexist with each other. In this event, the third terminal device 210-3 may monitor the SL transmission in the cellular wireless system. In view of this, in accordance with some example embodiments of the present disclosure, the OCB requirement may be defined per group. In other words, the combined OCB of the PSFCH from a group of receivers shall satisfy the OCB requirement.

In some embodiments, for unicast SL transmission, the allocated PSFCH resource may be determined by (P_{ID}) mod R, which means that the receiving terminal device sends the feedback in one interlace and determines m₀ as one of the configured CS pair values.

In some embodiments, for group cast option 1, the allocated PSFCH resource may be determined by (P_{ID}) mod R, which means the receiving terminal devices send the NACK sequence in one interlace and determine m₀ as one of the configured CS pair values.

In some embodiments, when the first terminal device 210-1 receives interlaced-based SL transmission via a group-cast, the first terminal device 210-1 determines at least one second resource for transmitting feedback information for the SL transmission, where the number of the at least one second resource is determined based on at least one of the following: a number of terminal devices involved in the group-cast, a number of the plurality of sets of interlaced resource blocks, and a number of cyclic shift pairs.

Additionally, in some embodiments, for group cast Option 2, the number of PRBs occupied by each terminal device is represented as ‘F’, where F is any of integers which satisfy R*N_{cs}>=M*F>=R, M is the group size, R is the PRB number within one interlace, N_{cs} is the number of the cyclic shift pairs. Additionally, parameter ‘F’ may be determined to be a specific value, such as, the minimum or the maximum of the integers which satisfy R*N_{cs}>=M*F>=R.

Additionally, in some embodiments, the feedback resource pool may be divided into X sets, where each of the sets comprises F PSFCH transmission resources, and the first terminal device 210-1 and the second terminal device 210-2 UE determine the PSFCH resource to be (M_{ID})mod X.

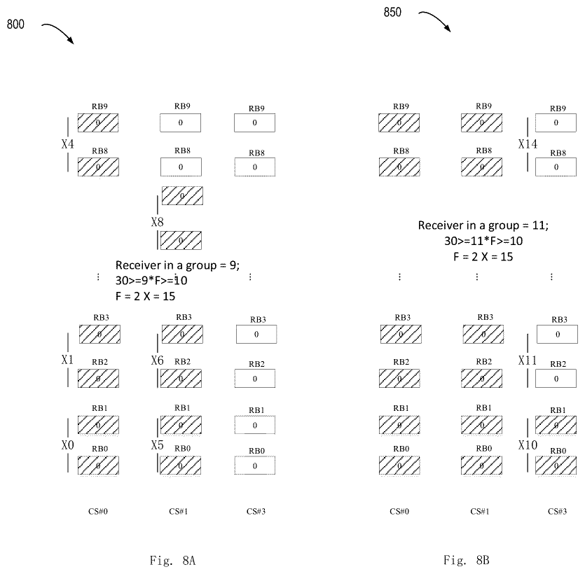

Reference is now made FIGS. 8A and 8B, which illustrate specific examples resource allocations 800 and 850 according to some embodiments of the present disclosure. In the specific example of FIG. 8A, the group size is M=9, and the number of PRBs in each interlace is R=10, the number of the cyclic shift pairs is N_{cs}=3. In this event, F is calculated to be 2, which is the minimum integer that satisfies R*N_{cs}>=M*F>=R.

In the specific example of FIG. 8B, the group size is M=23, and the number of PRBs in each interlace is R=10, the number of the cyclic shift pairs is N_{cs}=3. In this event, F is calculated to be 2, which is the maximum integer that satisfies R*N_{cs}>=M*F>=R.

Further, in some embodiments, the group size M is configured by higher layer of the transmitting terminal device and indicated in SCI to the receiving terminal device. In some embodiments, the first terminal device 210-1 receives information indicating the number of terminal devices involved in the group-cast from the second terminal device 210-2.

In some embodiments, at least one second resource is comprised in a feedback resource pool, and resources in the feedback resource pool are indexed in an order of from a frequency domain to a code domain.

In this way, especially for the scenario of group cast Option 2, each receiving terminal device is not necessarily needed to satisfy the OCB, as the OCB is defined per group.

### Example Processes for Configuring Multiple Symbols for PSFCH

In conventional solutions, the PSFCH slots occurs every 1/2/4 slots. Further, only one or two OFDM symbols are used for carrying PSFCH transmission within each PSFCH slot, and other available OFDM symbols are used for PSCCH/PSSCH transmission, as illustrated in FIG. 1A

In accordance with some example embodiments of the present disclosure, the first terminal device 210-1 and the second terminal device 210-2 determines at least one second resource for transmitting feedback information from multiple of OFDM symbols within a single slot (i.e., PSFCH slot). By configuring multiple of OFDM symbols for transmitting the feedback information within a single slot, the number of available PSFCH resources is increased.

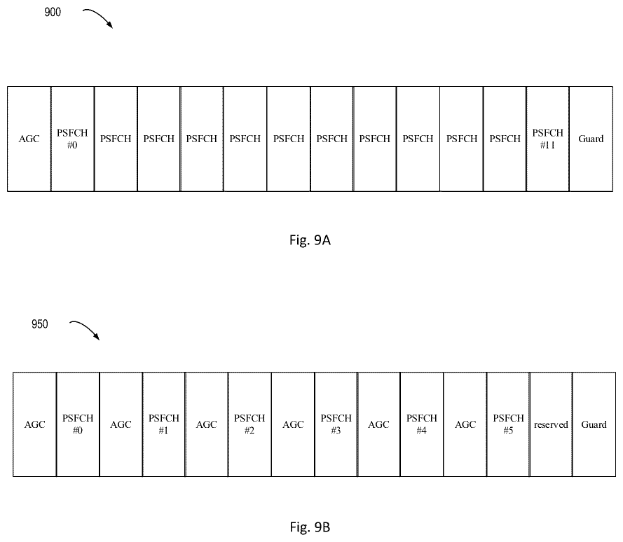

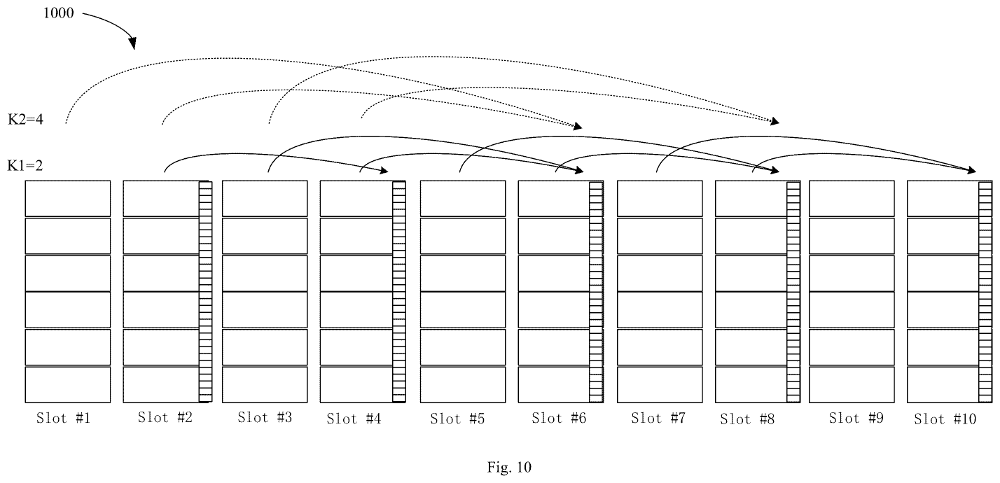

Additionally, in some embodiments, the multiple of OFDM symbols are all available OFDM symbols within the single slot. Reference is now made to FIG. 9A, which illustrates an example resource allocation 900 according to some embodiments of the present disclosure. In the specific example of FIG. 9A, the number of the available symbols within one slot is 12. In some embodiments, the available PSFCH resources may be configured for different terminal devices and/or different SL transmission occasions.

Additionally, considering different terminal devices may transmits PSFCH in different symbols, each PSFCH symbol may needs an AGC procedure. In some embodiments, one OFDM symbol for AGC is configured before each PSFCH symbol. Reference is now made to FIG. 9B, which illustrates an example resource allocation 950 according to some embodiments of the present disclosure. In the specific example embodiment of FIG. 9B, the AGC symbols and the PSFCH symbols are interleaved configured.

In this way, the number of available PSFCH transmission occasions is increased.

### Example Processes for Improving Reliability

As discussed above, a failure of transmission of feedback information would cause an unnecessary PSCCH/PSSCH re-transmission. Therefore, it is desirable to improve the reliability of feedback information transmission.

In accordance with some example embodiments of the present disclosure, the feedback resources for transmitting feedback information comprising a second resource and a third resource being different from the second resource.

In some embodiments, One PSSCH/PSCCH transmission could be mapped with more than one PSFCH slot. The more than one PSFCH slot may be configured in any suitable manner. In one specific embodiment, the more than one PSFCH slot are determine by configured more than one minimum slot gap between PSSCH and PSFCH (be represented as K₁, . . . , Kₘ). Additionally, each of the more than one minimum slot gap (i.e., Km) should be an integral multiple of PSFCH period.

Alternatively, in another specific embodiment, the first PSFCH slot is determined by configured one K, where K is the minimum slot gap between PSSCH and PSFCH, and the second PSFCH slot is the next available PSFCH slot, and the other PSFCH slot (if there is) is determined similarly.

In some embodiments, the first terminal device 210-1 receives a configuration from the second terminal device 210-2, where configuration indicating at least one of the following: a first minimum slot gap between the second resource and the first resource, and a second minimum slot gap between the third resource and the first resource.

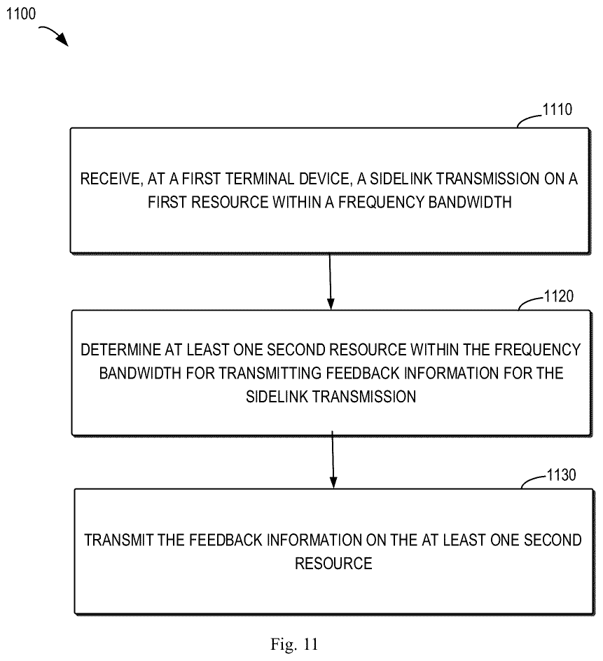

Reference is now made to FIG. 10, which an example resource allocation 1000 according to some embodiments of the present disclosure. As illustrated in the specific embodiment of FIG. 10, the feedback information for PSSCH/PSCCH transmission in slot #1 is carried in both slot #3 and slot #5.

Additionally, in some embodiments, the total PSFCH resource in one PSFCH slot (such as, slot #2, #4, $6, #8 or #10) is equally divided to more than one set. Further, each set contains P*S PSFCH resources, where P is the PSFCH period and S is the possible PSSCH occasion in one slot.

In this way, the reliability of the feedback information is improved and the unnecessary PSSCH/PSCCH re-transmission is avoided thereby.

### Example Methods

FIG. 11 illustrates a flowchart of an example method 1100 in accordance with some embodiments of the present disclosure. For example, the method 1100 can be implemented at the first terminal device 210-1 as shown in FIG. 2.

At block 1110, the first terminal device 210-1 receives a SL transmission on a first resource within a frequency bandwidth.

At block 1120, the first terminal device 210-1 determines at least one second resource within the frequency bandwidth for transmitting feedback information for the SL transmission, a frequency range occupied by the at least one second resource exceeding or being equal to a predefined percentage of the bandwidth, the at least one second resource comprising a common second resource.

At block 1130, the first terminal device 210-1 transmits the feedback information on the at least one second resource.

In some example embodiments, the feedback information transmitted in the common second resource is pre-defined common feedback information.

In some example embodiments, the pre-defined common feedback information is one of the following: a pre-defined sequence for a physical uplink control channel message, or a reference signal.

In some example embodiments, the frequency bandwidth comprises a plurality of sets of interlaced resource blocks in frequency domain, and the common second resource corresponds to one of the plurality of sets of interlaced resource blocks.

In some example embodiments, the SL transmission is an interlace-based SL transmission and the common second resource corresponds to a first interlace index. The circuitry is further configured to disable receiving a SL transmission transmitted on a resource corresponding to the first interlace index, or disable transmitting feedback information for a SL transmission transmitted on a resource corresponding to the first interlace index.

In some example embodiments, the SL transmission is an interlace-based SL transmission and the common second resource corresponds to a first interlace index. Further, if the first resource corresponds to the first interlace index or a second interlace index, the at least one second resource comprises: the common second resource, and a dedicated second resource being specific to the SL transmission.

In some example embodiments, the dedicated second resource is determined based on at least one of the following: a number of the plurality of sets of interlaced resource blocks, an interlace index corresponding to the at least one first resource, and a period for transmitting the feedback information.

In some example embodiments, if a number of sets of interlaced resource blocks occupied by the SL transmission is larger than one, the dedicated second resource is determined further based on the number of sets of interlaced resource blocks occupied by the SL transmission.

In some example embodiments, the common second resource is configured by a second terminal device 210-2 transmitting the SL transmission or determined according to a default configuration.

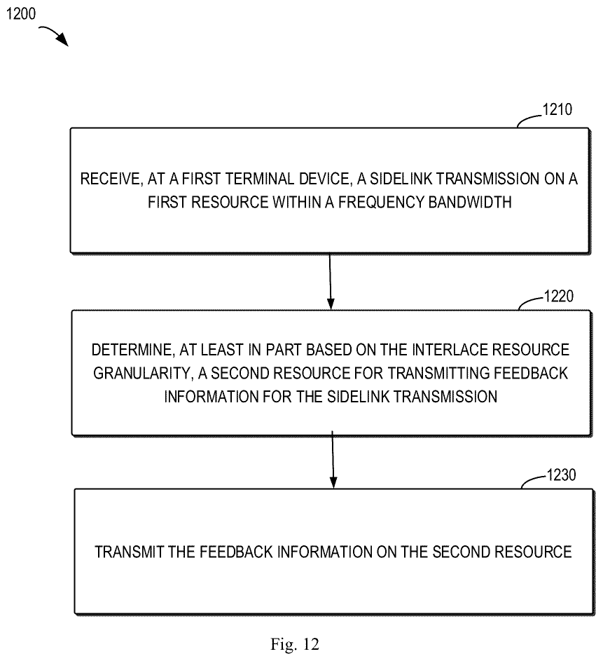

FIG. 12 illustrates a flowchart of an example method 1200 in accordance with some embodiments of the present disclosure. For example, the method 1200 can be implemented at the first terminal device 210-1 as shown in FIG. 2.

At block 1210, the first terminal device 210-1 receives an interlaced-based SL transmission on at least one first resource, the interlace-based SL transmission being transmitted with an interlace resource granularity larger than one.

At block 1220, the first terminal device 210-1 determines, at least in part based on the interlace resource granularity, a second resource for transmitting feedback information for the SL transmission.

At block 1230, the first terminal device 210-1 transmits the feedback information on the second resource.

In some example embodiments, the second resource is comprised in a feedback resource pool, and resources in the feedback resource pool are indexed in an order of from a frequency domain to a code domain.

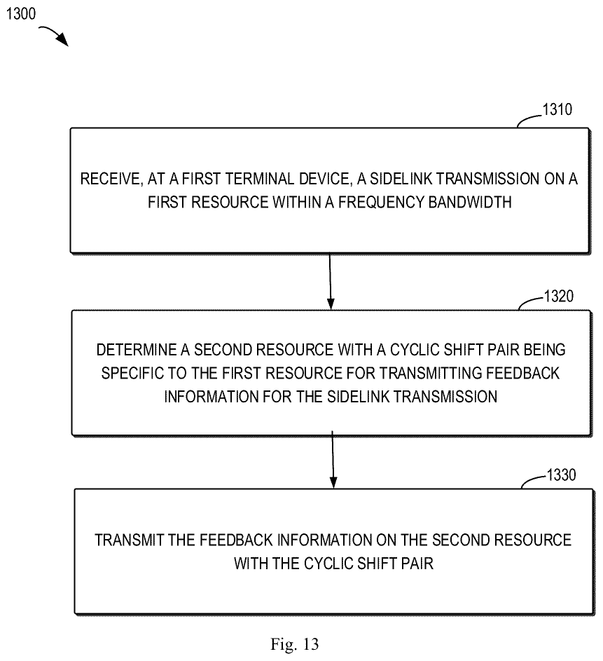

FIG. 13 illustrates a flowchart of an example method 1300 in accordance with some embodiments of the present disclosure. For example, the method 1300 can be implemented at the first terminal device 210-1 as shown in FIG. 2.

At block 1310, the first terminal device 210-1 receives a SL transmission on a first resource.

At block 1320, the first terminal device 210-1 determines a second resource with a cyclic shift pair being specific to the first resource for transmitting feedback information for the SL transmission.

At block 1330, the first terminal device 210-1 transmits the feedback information on the second resource with the cyclic shift pair.

In some example embodiments, the cyclic shift pair is determined based on a pre-configured correspondence between: a distance between the first resource and the second resource in time domain, and an index of the cyclic shift pair.

In some example embodiments, the first terminal device 210-1 applies a feedback configuration about one of the following: disabling SL transmission transmitted via a group-cast; or enabling feedback information only comprising negative-acknowledgement.

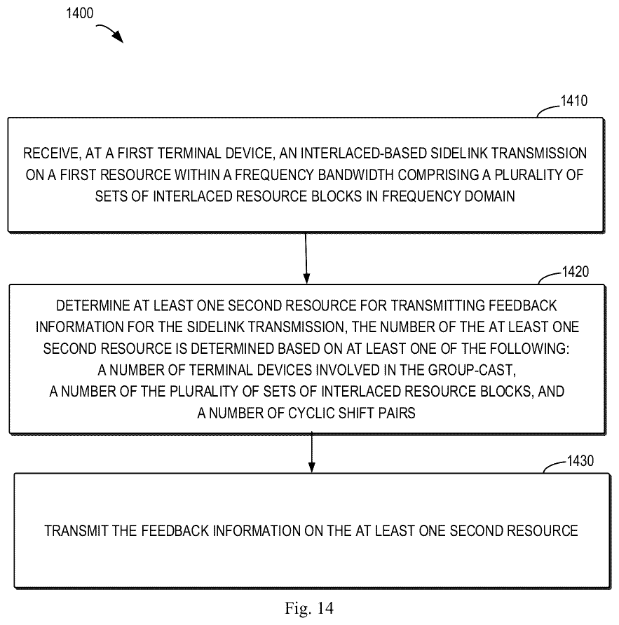

FIG. 14 illustrates a flowchart of an example method 1400 in accordance with some embodiments of the present disclosure. For example, the method 1400 can be implemented at the first terminal device 210-1 as shown in FIG. 2.

At block 1410, the first terminal device 210-1 receives an interlaced-based SL transmission on a first resource within a frequency bandwidth comprising a plurality of sets of interlaced resource blocks in frequency domain, the interlaced-based SL transmission is transmitted by a second terminal device 210-2 via a group-cast.

At block 1420, the first terminal device 210-1 determines at least one second resource for transmitting feedback information for the SL transmission, the number of the at least one second resource is determined based on at least one of the following: a number of terminal devices involved in the group-cast, a number of the plurality of sets of interlaced resource blocks, and a number of cyclic shift pairs.

At block 1430, the first terminal device 210-1 transmits the feedback information on the at least one second resource.

In some example embodiments, the at least one second resource is comprised in a feedback resource pool, and resources in the feedback resource pool are indexed in an order of from a frequency domain to a code domain.

In some example embodiments, the first terminal device 210-1 receives, from the second terminal device 210-2, information indicating the number of terminal devices involved in the group-cast.

In some example embodiments, the first terminal device 210-1 applies a rule for evaluating an occupied channel bandwidth as below: evaluating the occupied channel bandwidth by summing frequency resources occupied by all of terminal devices involved in a group-cast SL transmission.

In some example embodiments, the first terminal device 210-1 receives, from the second terminal device 210-2, an indication to enable applying the rule for evaluating the occupied channel bandwidth.

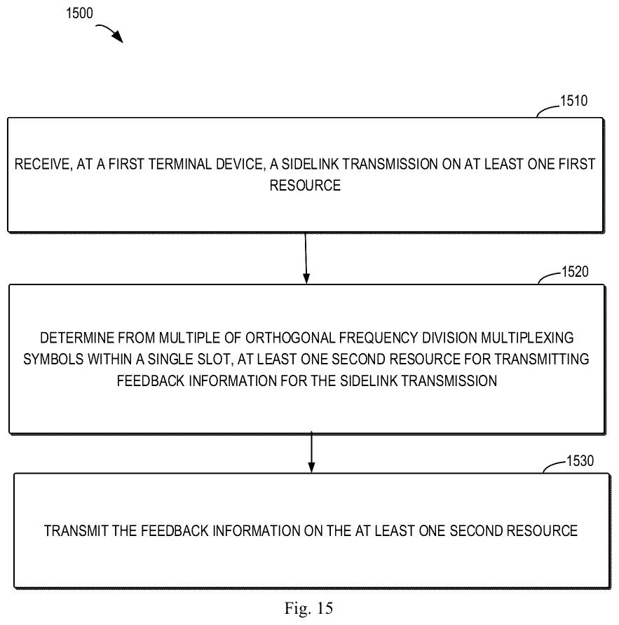

FIG. 15 illustrates a flowchart of an example method 1500 in accordance with some embodiments of the present disclosure. For example, the method 1500 can be implemented at the first terminal device 210-1 as shown in FIG. 2.

At block 1510, the first terminal device 210-1 receives a SL transmission on at least one first resource.

At block 1520, the first terminal device 210-1 determines, from multiple of orthogonal frequency division multiplexing symbols within a single slot, at least one second resource for transmitting feedback information for the SL transmission.

At block 1530, the first terminal device 210-1 transmits the feedback information on the at least one second resource.

In some example embodiments, the multiple of orthogonal frequency division multiplexing symbols are all available orthogonal frequency division multiplexing symbols within the single slot.

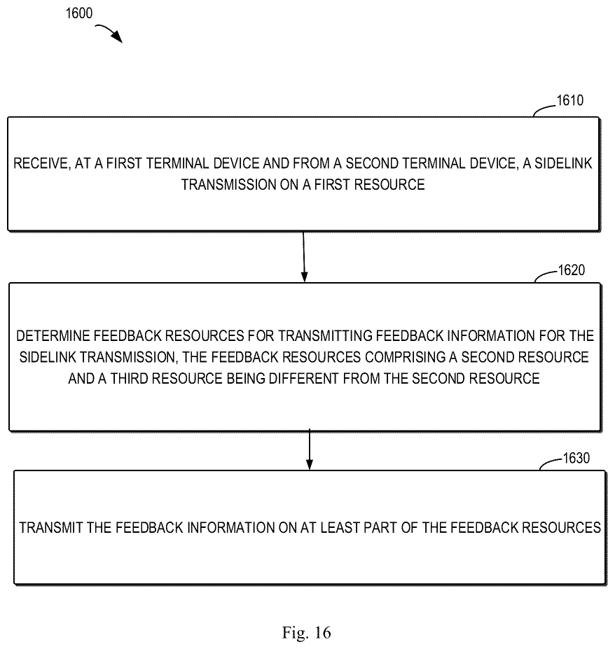

FIG. 16 illustrates a flowchart of an example method 1600 in accordance with some embodiments of the present disclosure. For example, the method 1600 can be implemented at the first terminal device 210-1 as shown in FIG. 2.

At block 1610, the first terminal device 210-1 receives, from a second terminal device 210-2, a SL transmission on a first resource.

At block 1620, the first terminal device 210-1 determines, feedback resources for transmitting feedback information for the SL transmission, the feedback resources comprising a second resource and a third resource being different from the second resource.

At block 1630, the first terminal device 210-1 transmits the feedback information on at least part of the feedback resources.

In some example embodiments, the first terminal device 210-1 receives, from the second terminal device 210-2, a configuration indicating at least one of the following: a first minimum slot gap between the second resource and the first resource, and a second minimum slot gap between the third resource and the first resource.

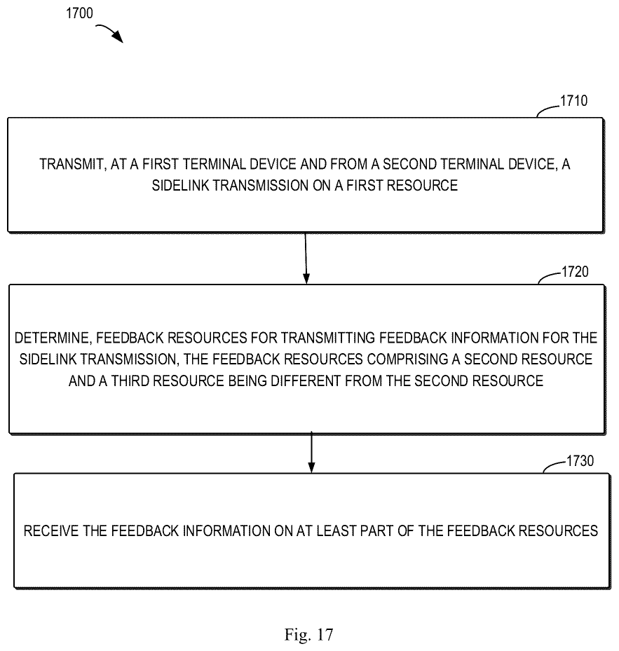

FIG. 17 illustrates a flowchart of an example method 1700 in accordance with some embodiments of the present disclosure. For example, the method 1700 can be implemented at the second terminal device 210-2 as shown in FIG. 2.

At block 1710, the second terminal device 210-2 transmits a SL transmission on a first resource within a frequency bandwidth.

At block 1720, the second terminal device 210-2 determines at least one second resource within the frequency bandwidth for receiving feedback information for the SL transmission, a frequency range occupied by the at least one second resource exceeding or being equal to a predefined percentage of the bandwidth, the at least one second resource comprising a common second resource.

At block 1730, the second terminal device 210-2 receives the feedback information on the least one second resource.

In some example embodiments, the feedback information transmitted in the common second resource is pre-defined common feedback information.

In some example embodiments, the pre-defined common feedback information is one of the following: a pre-defined sequence for a physical uplink control channel message, or a reference signal.

In some example embodiments, the frequency bandwidth comprises a plurality of sets of interlaced resource blocks in frequency domain, and the common second resource corresponds to one of the sets of interlaced resource blocks.

In some example embodiments, the SL transmission is an interlace-based SL transmission and the common second resource corresponds to a first interlace index. The circuitry is further configured to disable transmitting a SL transmission on a resource corresponding to the first interlace index, avoid selecting the resource corresponding to the first interlace index to be used for a SL transmission during resource (re) selection, or disable feedback information transmission for a SL transmission transmitted on a resource corresponding to the first interlace index.

In some example embodiments, the SL transmission is an interlaced based SL transmission and the common second resource is corresponding to a first interlace index. Further, if the first resource corresponds to the first interlace index or a second interlace index, the at least one second resource comprises: the common second resource, and a dedicated second resource being specific to the SL transmission.

In some example embodiments, the dedicated second resource is determined based on at least one of the following: a number of the plurality of sets of interlaced resource blocks, an interlace index corresponding to the at least one first resource, and a period for transmitting the feedback information.

In some example embodiments, if a number of sets of interlaced resource blocks occupied by the SL transmission is larger than one, the dedicated second resource is determined further based on the number of sets of interlaced resource blocks occupied by the SL transmission.

In some example embodiments, the common second resource is configured by the second terminal device 210-2 or determined according to a default configuration.

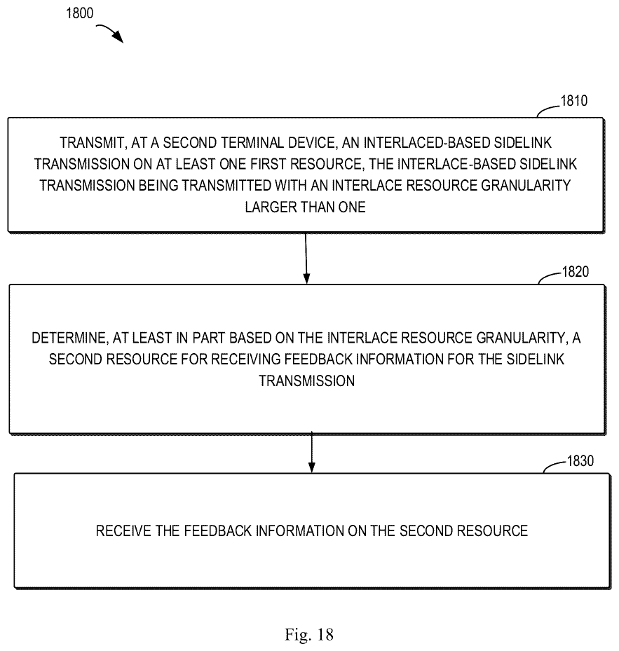

FIG. 18 illustrates a flowchart of an example method 1800 in accordance with some embodiments of the present disclosure. For example, the method 1800 can be implemented at the second terminal device 210-2 as shown in FIG. 2.

At block 1810, the second terminal device 210-2 transmits an interlaced-based SL transmission on at least one first resource, the interlace-based SL transmission being transmitted with an interlace resource granularity larger than one.

At block 1820, the second terminal device 210-2 determines at least in part based on the interlace resource granularity, a second resource for receiving feedback information for the SL transmission.

At block 1820, the second terminal device 210-receives the feedback information on the second resource.

In some example embodiments, the second resource is comprised in a feedback resource pool, and resources in the feedback resource pool are indexed in an order of from a frequency domain to a code domain.

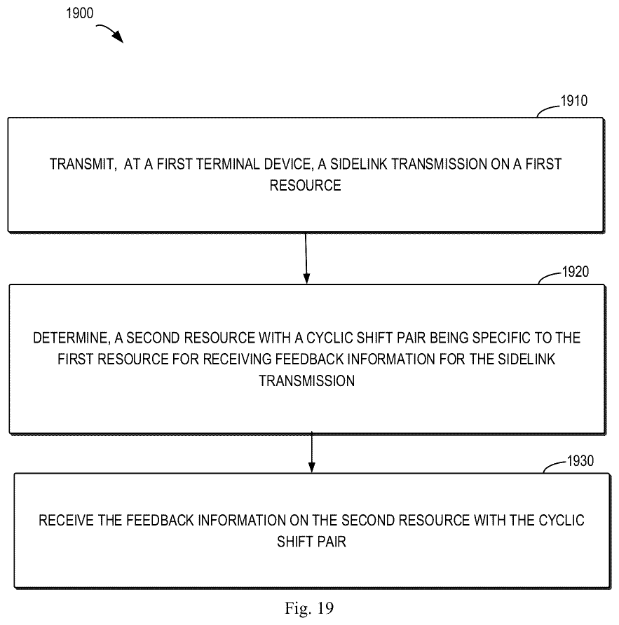

FIG. 19 illustrates a flowchart of an example method 1900 in accordance with some embodiments of the present disclosure. For example, the method 1900 can be implemented at the second terminal device 210-2 as shown in FIG. 2.

At block 1910, the second terminal device 210-2 transmits, at a first terminal device 210-1, a SL transmission on a first resource.

At block 1920, the second terminal device 210-2 determines a second resource with a cyclic shift pair being specific to the first resource for receiving feedback information for the SL transmission.

At block 1930, the second terminal device 210-2 receives the feedback information on the second resource with the cyclic shift pair.

In some example embodiments, the cyclic shift pair is determined based on a pre-configured correspondence between: a distance between the first resource and the second resource in time domain, and an index of the cyclic shift pair.

In some example embodiments, the second terminal device 210-2 to applies a feedback configuration about one of the following: disabling SL transmission transmitted via a group-cast; or enabling feedback information only comprising negative-acknowledgement.

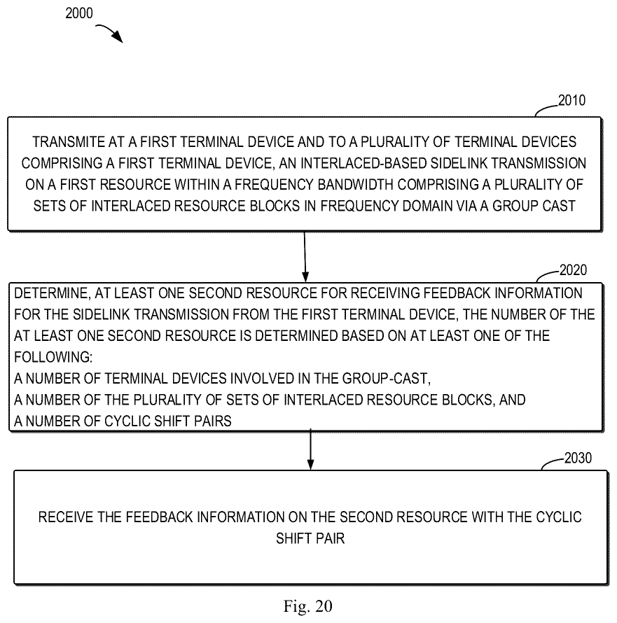

FIG. 20 illustrates a flowchart of an example method 2000 in accordance with some embodiments of the present disclosure. For example, the method 2000 can be implemented at the second terminal device 210-2 as shown in FIG. 2.

At block 2010, the second terminal device 210-2 transmits to a plurality of terminal devices comprising a first terminal device 210-1, an interlaced-based SL transmission on a first resource within a frequency bandwidth comprising a plurality of sets of interlaced resource blocks in frequency domain via a group-cast.

At block 2020, the second terminal device 210-2 determines at least one second resource for receiving feedback information for the SL transmission from the first terminal device 210-1, the number of the at least one second resource is determined based on at least one of the following: a number of terminal devices involved in the group-cast, a number of the plurality of sets of interlaced resource blocks, and a number of cyclic shift pairs.

At block 2030, the second terminal device 210-2 receives the feedback information on the at least one second resource.

In some example embodiments, at least one second resource is comprised in a feedback resource pool, and resources in the feedback resource pool are indexed in an order of from a frequency domain to a code domain.

In some example embodiments, the second terminal device 210-2 transmits, to the first terminal device 210-1, information indicating to the number of terminal devices involved in the group-cast.

In some example embodiments, the second terminal device 210-2 applies a rule for evaluating an occupied channel bandwidth as below: evaluating the occupied channel bandwidth by summing frequency resources occupied by all of terminal devices involved in a group-cast SL transmission.

In some example embodiments, the second terminal device 210-2 transmits, to the plurality of terminal device, an indication to enable applying the rule for evaluating the occupied channel bandwidth.

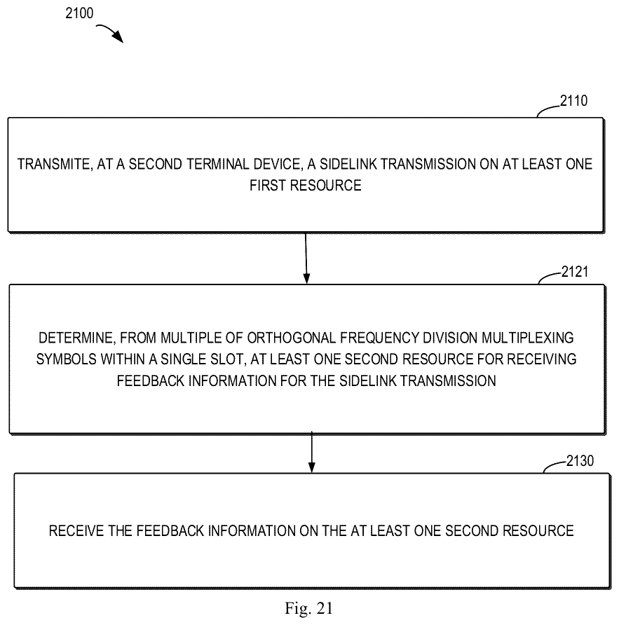

FIG. 21 illustrates a flowchart of an example method 2100 in accordance with some embodiments of the present disclosure. For example, the method 2100 can be implemented at the second terminal device 210-2 as shown in FIG. 2.

At block 2110, the second terminal device 210-2 transmits a SL transmission on at least one first resource

At block 2120, the second terminal device 210-2 determines from multiple of orthogonal frequency division multiplexing symbols within a single slot, at least one second resource for receiving feedback information for the SL transmission

At block 2130, the second terminal device 210-2 receives the feedback information on the at least one second resource.

In some example embodiments, the multiple of orthogonal frequency division multiplexing symbols are all available orthogonal frequency division multiplexing symbols within the single slot.

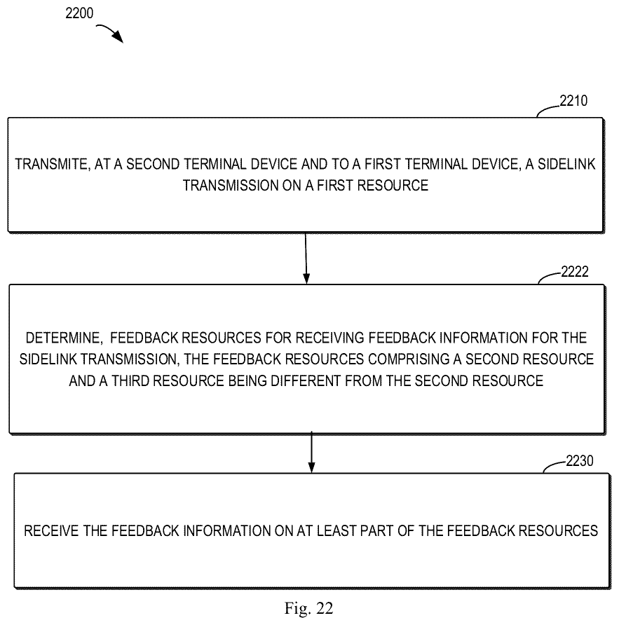

FIG. 22 illustrates a flowchart of an example method 2200 in accordance with some embodiments of the present disclosure. For example, the method 2200 can be implemented at the second terminal device 210-2 as shown in FIG. 2.

At block 2210, the second terminal device 210-2 transmits to a first terminal device 210-1, a SL transmission on a first resource.

At block 2220, the second terminal device 210-2 determines feedback resources for receiving feedback information for the SL transmission, the feedback resources comprising a second resource and a third resource being different from the second resource.

At block 2230, the second terminal device 210-2 receives the feedback information on at least part of the feedback resources.

In some example embodiments, the circuitry is further configured to transmit, to the first terminal device 210-1, a configuration indicating at least one of the following: a first minimum slot gap between the second resource and the first resource, and a second minimum slot gap between the third resource and the first resource.

### Example Devices

In some example embodiments, the first terminal device 210-1 comprises circuitry configured to: receive a SL transmission on a first resource within a frequency bandwidth; determine at least one second resource within the frequency bandwidth for transmitting feedback information for the SL transmission, a frequency range occupied by the at least one second resource exceeding or being equal to a predefined percentage of the bandwidth, the at least one second resource comprising a common second resource; and transmit the feedback information on the at least one second resource.

In some example embodiments, the feedback information transmitted in the common second resource is pre-defined common feedback information.

In some example embodiments, the pre-defined common feedback information is one of the following: a pre-defined sequence for a physical uplink control channel message, or a reference signal.

In some example embodiments, the frequency bandwidth comprises a plurality of sets of interlaced resource blocks in frequency domain, and the common second resource corresponds to one of the plurality of sets of interlaced resource blocks.

In some example embodiments, the SL transmission is an interlace-based SL transmission and the common second resource corresponds to a first interlace index. The circuitry is further configured to disable receiving a SL transmission transmitted on a resource corresponding to the first interlace index, or disable transmitting feedback information for a SL transmission transmitted on a resource corresponding to the first interlace index.

In some example embodiments, the SL transmission is an interlace-based SL transmission and the common second resource corresponds to a first interlace index. Further, if the first resource corresponds to the first interlace index or a second interlace index, the at least one second resource comprises: the common second resource, and a dedicated second resource being specific to the SL transmission.

In some example embodiments, the dedicated second resource is determined based on at least one of the following: a number of the plurality of sets of interlaced resource blocks, an interlace index corresponding to the at least one first resource, and a period for transmitting the feedback information.

In some example embodiments, if a number of sets of interlaced resource blocks occupied by the SL transmission is larger than one, the dedicated second resource is determined further based on the number of sets of interlaced resource blocks occupied by the SL transmission.

In some example embodiments, the common second resource is configured by a second terminal device 210-2 transmitting the SL transmission or determined according to a default configuration.

In some example embodiments, the first terminal device 210-1 comprises circuitry configured to: receive, at a first terminal device 210-1, an interlaced-based SL transmission on at least one first resource, the interlace-based SL transmission being transmitted with an interlace resource granularity larger than one; determine, at least in part based on the interlace resource granularity, a second resource for transmitting feedback information for the SL transmission; and transmit the feedback information on the second resource.

In some example embodiments, the second resource is comprised in a feedback resource pool, and resources in the feedback resource pool are indexed in an order of from a frequency domain to a code domain.

In some example embodiments, the first terminal device 210-1 comprises circuitry configured to: receive a SL transmission on a first resource; determine a second resource with a cyclic shift pair being specific to the first resource for transmitting feedback information for the SL transmission; and transmit the feedback information on the second resource with the cyclic shift pair.

In some example embodiments, the cyclic shift pair is determined based on a pre-configured correspondence between: a distance between the first resource and the second resource in time domain, and an index of the cyclic shift pair.

In some example embodiments, the circuitry is further configured to apply a feedback configuration about one of the following: disabling SL transmission transmitted via a group-cast; or enabling feedback information only comprising negative-acknowledgement.

In some example embodiments, the first terminal device 210-1 comprises circuitry configured to: receive an interlaced-based SL transmission on a first resource within a frequency bandwidth comprising a plurality of sets of interlaced resource blocks in frequency domain, the interlaced-based SL transmission is transmitted by a second terminal device 210-2 via a group-cast; determine at least one second resource for transmitting feedback information for the SL transmission, the number of the at least one second resource is determined based on at least one of the following: a number of terminal devices involved in the group-cast, a number of the plurality of sets of interlaced resource blocks, and a number of cyclic shift pairs; and transmit the feedback information on the at least one second resource.

In some example embodiments, the at least one second resource is comprised in a feedback resource pool, and resources in the feedback resource pool are indexed in an order of from a frequency domain to a code domain.

In some example embodiments, the circuitry is further configured to receive, from the second terminal device 210-2, information indicating the number of terminal devices involved in the group-cast.

In some example embodiments, the circuitry is further configured to apply a rule for evaluating an occupied channel bandwidth as below: evaluating the occupied channel bandwidth by summing frequency resources occupied by all of terminal devices involved in a group-cast SL transmission.

In some example embodiments, the circuitry is further configured to receive, from the second terminal device 210-2, an indication to enable applying the rule for evaluating the occupied channel bandwidth.

In some example embodiments, the first terminal device 210-1 comprises circuitry configured to: receive, at a first terminal device 210-1, a SL transmission on at least one first resource; determine, from multiple of orthogonal frequency division multiplexing symbols within a single slot, at least one second resource for transmitting feedback information for the SL transmission; and transmit the feedback information on the at least one second resource.

In some example embodiments, the multiple of orthogonal frequency division multiplexing symbols are all available orthogonal frequency division multiplexing symbols within the single slot.

In some example embodiments, the first terminal device 210-1 comprises circuitry configured to: receive, from a second terminal device 210-2, a SL transmission on a first resource; determine, feedback resources for transmitting feedback information for the SL transmission, the feedback resources comprising a second resource and a third resource being different from the second resource; and transmit the feedback information on at least part of the feedback resources.

In some example embodiments, the circuitry is further configured to receive, from the second terminal device 210-2, a configuration indicating at least one of the following: a first minimum slot gap between the second resource and the first resource, and a second minimum slot gap between the third resource and the first resource.

In some example embodiments, the second terminal device 210-2 comprises circuitry configured to: transmit a SL transmission on a first resource within a frequency bandwidth; determine, at least one second resource within the frequency bandwidth for receiving feedback information for the SL transmission, a frequency range occupied by the at least one second resource exceeding or being equal to a predefined percentage of the bandwidth, the at least one second resource comprising a common second resource; and receive, the feedback information on the least one second resource.

In some example embodiments, the feedback information transmitted in the common second resource is pre-defined common feedback information.

In some example embodiments, the pre-defined common feedback information is one of the following: a pre-defined sequence for a physical uplink control channel message, or a reference signal.

In some example embodiments, the frequency bandwidth comprises a plurality of sets of interlaced resource blocks in frequency domain, and the common second resource corresponds to one of the sets of interlaced resource blocks.

In some example embodiments, the SL transmission is an interlace-based SL transmission and the common second resource corresponds to a first interlace index. The circuitry is further configured to disable transmitting a SL transmission on a resource corresponding to the first interlace index, avoid selecting the resource corresponding to the first interlace index to be used for a SL transition, or disable feedback information transmission for a SL transmission transmitted on a resource corresponding to the first interlace index.

In some example embodiments, the SL transmission is an interlaced based SL transmission and the common second resource is corresponding to a first interlace index. Further, if the first resource corresponds to the first interlace index or a second interlace index, the at least one second resource comprises: the common second resource, and a dedicated second resource being specific to the SL transmission.

In some example embodiments, the dedicated second resource is determined based on at least one of the following: a number of the plurality of sets of interlaced resource blocks, an interlace index corresponding to the at least one first resource, and a period for transmitting the feedback information.

In some example embodiments, if a number of sets of interlaced resource blocks occupied by the SL transmission is larger than one, the dedicated second resource is determined further based on the number of sets of interlaced resource blocks occupied by the SL transmission.

In some example embodiments, the common second resource is configured by the second terminal device 210-2 or determined according to a default configuration.

In some example embodiments, the second terminal device 210-2 comprises circuitry configured to: transmit an interlaced-based SL transmission on at least one first resource, the interlace-based SL transmission being transmitted with an interlace resource granularity larger than one; determine, at least in part based on the interlace resource granularity, a second resource for receiving feedback information for the SL transmission; and receive the feedback information on the second resource.

In some example embodiments, the second resource is comprised in a feedback resource pool, and resources in the feedback resource pool are indexed in an order of from a frequency domain to a code domain.

In some example embodiments, the second terminal device 210-2 comprises circuitry configured to: transmit, at a first terminal device 210-1, a SL transmission on a first resource, determine a second resource with a cyclic shift pair being specific to the first resource for receiving feedback information for the SL transmission; and receive the feedback information on the second resource with the cyclic shift pair.

In some example embodiments, the cyclic shift pair is determined based on a pre-configured correspondence between: a distance between the first resource and the second resource in time domain, and an index of the cyclic shift pair.

In some example embodiments, the circuitry is further configured to apply a feedback configuration about one of the following: disabling SL transmission transmitted via a group-cast; or enabling feedback information only comprising negative-acknowledgement.

In some example embodiments, the second terminal device 210-2 comprises circuitry configured to: transmit to a plurality of terminal devices comprising a first terminal device 210-1, an interlaced-based SL transmission on a first resource within a frequency bandwidth comprising a plurality of sets of interlaced resource blocks in frequency domain via a group-cast; determine at least one second resource for receiving feedback information for the SL transmission from the first terminal device 210-1, the number of the at least one second resource is determined based on at least one of the following: a number of terminal devices involved in the group-cast, a number of the plurality of sets of interlaced resource blocks, and a number of cyclic shift pairs; and receive the feedback information on the at least one second resource.

In some example embodiments, at least one second resource is comprised in a feedback resource pool, and resources in the feedback resource pool are indexed in an order of from a frequency domain to a code domain.

In some example embodiments, the circuitry is further configured to transmit, to the first terminal device 210-1, information indicating to the number of terminal devices involved in the group-cast.

In some example embodiments, the circuitry is further configured to apply a rule for evaluating an occupied channel bandwidth as below: evaluating the occupied channel bandwidth by summing frequency resources occupied by all of terminal devices involved in a group-cast SL transmission.

In some example embodiments, the circuitry is further configured to transmit, to the plurality of terminal device, an indication to enable applying the rule for evaluating the occupied channel bandwidth.

In some example embodiments, the second terminal device 210-2 comprises circuitry configured to: transmit a SL transmission on at least one first resource; determine, from multiple of orthogonal frequency division multiplexing symbols within a single slot, at least one second resource for receiving feedback information for the SL transmission; and receive the feedback information on the at least one second resource.

In some example embodiments, the multiple of orthogonal frequency division multiplexing symbols are all available orthogonal frequency division multiplexing symbols within the single slot.

In some example embodiments, the second terminal device 210-2 comprises circuitry configured to: transmit, to a first terminal device 210-1, a SL transmission on a first resource; determine, feedback resources for receiving feedback information for the SL transmission, the feedback resources comprising a second resource and a third resource being different from the second resource; and receive the feedback information on at least part of the feedback resources.

In some example embodiments, the circuitry is further configured to transmit, to the first terminal device 210-1, a configuration indicating at least one of the following: a first minimum slot gap between the second resource and the first resource, and a second minimum slot gap between the third resource and the first resource.

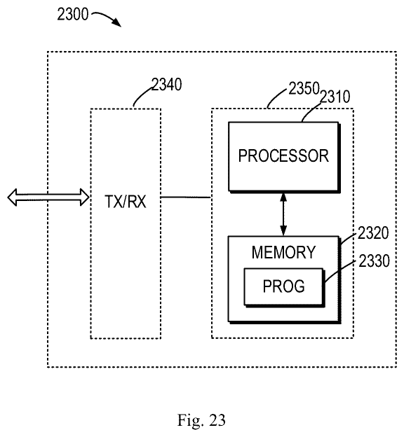

FIG. 23 is a simplified block diagram of a device 2300 that is suitable for implementing embodiments of the present disclosure. The device 2300 can be considered as a further example implementation of the terminal first terminal device 210-1 and the second terminal device 210-2 as shown in FIG. 2. Accordingly, the device 2300 can be implemented at or as at least a part of the terminal device 210, the access network device 230 and the CN device 220.

As shown, the device 2300 includes a processor 2310, a memory 2320 coupled to the processor 2310, a suitable transmitter (TX) and receiver (RX) 2340 coupled to the processor 2310, and a communication interface coupled to the TX/RX 2340. The memory 2310 stores at least a part of a program 2330. The TX/RX 2340 is for bidirectional communications. The TX/RX 2340 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 2330 is assumed to include program instructions that, when executed by the associated processor 2310, enable the device 2300 to operate in accordance with the embodiments of the present disclosure, as discussed herein with reference to FIGS. 2-10. The embodiments herein may be implemented by computer software executable by the processor 2310 of the device 2300, or by hardware, or by a combination of software and hardware. The processor 2310 may be configured to implement various embodiments of the present disclosure. Furthermore, a combination of the processor 2310 and memory 2320 may form processing means 2350 adapted to implement various embodiments of the present disclosure.

The memory 2320 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 2320 is shown in the device 2300, there may be several physically distinct memory modules in the device 2300. The processor 2310 may be of any type suitable to the local technical network, and may include one or more of general purpose computers, special purpose computers, microprocessors, digital signal processors (DSPs) and processors based on multicore processor architecture, as non-limiting examples. The device 2300 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 11-22. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-49. (canceled)

50. A method performed by a first terminal device communicating with a second terminal device via a sidelink channel, the method comprises:
receiving, from the second terminal device, a first sidelink transmission within a first frequency bandwidth;
determining at least one first resource for transmitting feedback information in response to the first sidelink transmission,
the at least one first resource being within the first frequency bandwidth,
the at least one first resource comprising a common resource,
the common resource being determined based on first information received from a network, and
transmitting the feedback information on the at least one first resource.

51. The method according to claim 50, wherein
the first frequency bandwidth comprises a plurality of sets of interlaced resource blocks in frequency domain, and
the common resource corresponds to one set of the plurality of sets of interlaced resource blocks.

52. The method according to claim 50, wherein
the sidelink transmission is an interlace-based sidelink transmission.

53. The method according to claim 50, wherein
an index for the common resource corresponds to an index of first interlace.

54. The method according to claim 50, wherein
the at least one first resource comprises the common resource and at least one dedicated resource.

55. A first terminal device communicating with a second terminal device via a sidelink channel, the first terminal device comprises:
one or more memories storing instructions; and
one or more processors configured to process the instructions to control the first terminal device to:
receive, from the second terminal device, a first sidelink transmission within a first frequency bandwidth;
determine at least one first resource for transmitting feedback information in response to the first sidelink transmission,
the at least one first resource being within the first frequency bandwidth,
the at least one first resource comprising a common resource,
the common resource being determined based on first information received from a network, and
transmit the feedback information on the at least one first resource.

56. The first terminal device according to claim 55, wherein
the first frequency bandwidth comprises a plurality of sets of interlaced resource blocks in frequency domain, and
the common resource corresponds to one set of the plurality of sets of interlaced resource blocks.

57. The first terminal device according to claim 55, wherein
the sidelink transmission is an interlace-based sidelink transmission.

58. The first terminal device according to claim 55, wherein
an index for the common resource corresponds to an index of first interlace.

59. The first terminal device according to claim 55, wherein
the at least one first resource comprises the common resource and at least one dedicated resource.
